(19) United States
(12) Patent Application Publication
(10) Pub. No.: US 2025/0135715 A1
(43) Pub. Date: May 1, 2025

(54) VASCULAR NETWORK INSPIRED FLUIDIC SYSTEM FOR SPATIOTEMPORAL REGULATION OF FLUID COMPONENTS

(71) Applicants: The University of Hong Kong, Hong Kong (CN); Advanced Biomedical Instrumentation Centre Limited, Hong Kong (CN)

(72) Inventors: Yafeng Yu, Hong Kong (CN); Ho Cheung Shum, Hong Kong (CN); Yi Pan, Hong Kong (CN); Jingxuan Tian, Hong Kong (CN); Wei Guo, Hong Kong (CN)

(73) Assignees: The University of Hong Kong, Hong Kong (CN); Advanced Biomedical Instrumentation Centre Limited, Hong Kong (CN)

(21) Appl. No.: 18/912,551

(22) Filed: Oct. 10, 2024

Related U.S. Application Data
(60) Provisional application No. 63/589,549, filed on Oct. 11, 2023.

(51) Int. Cl. B29C 64/124; B29C 64/209; B29K 33/00; B33Y 10/00; B33Y 30/00; B33Y 80/00; C08L 33/26

(52) U.S. Cl. CPC B29C 64/124; B29C 64/209; B33Y 10/00; B33Y 30/00; B33Y 80/00; C08L 33/26; B29K 2033/26

(57) ABSTRACT

A method and apparatus for forming vascular-like channels involves liquid-in-liquid 3D printing utilizing two polymer solutions used as a printing ink and a matrix. Anionic polyacrylamide (APAM) is one of the polymer solutions and acts as the matrix material. Chitosan is the other polymer solution and acts as the printing ink. The chitosan printing ink is extruded through a print nozzle of a 3D printer onto the APAM matrix which covers the bottom of a petri dish while the nozzle is moved in a desired pattern for the channels. The chitosan and APAM polymer complexes self-assemble on the ink-matrix interface, locking chitosan polymers inside the matrix before they can spread and causing the formation of soft elastic membranous walls. The chitosan ink and APAM matrix can be removed after the polymer complex self-assembly. The printed chamber with membranous walls allows for liquid infusion to work as fluidic channels.

### CROSS-REFERENCE TO RELATED PATENT APPLICATIONS

This application claims the benefit of priority under 35 U.S.C. Section 119(e) of U.S. Application No. 63/589,549, filed Oct. 11, 2023, which is incorporated herein by reference in its entirety.

### FIELD OF THE INVENTION

The present invention relates to fluidic systems, and more particularly to fluidic systems with soft membranous channel walls that can vary fluid compositions among separate regions.

### BACKGROUND OF THE INVENTION

As a biological fluidic system, the vascular network has evolved to self-modulate chemical compositions of blood efficiently through transport across micro-vessel walls. For instance, capillaries around digestive organs allow glucose to enter to the organ to increase blood glucose concentration, while alveolar micro-vessels enable gas exchange to decrease carbon dioxide concentration in blood [1, 2]. The variable trans-wall molecules among different vessels change fluid compositions from region to region. The high efficiency of trans-wall transport is ensured by the ultrathin (≈1 μm) walls [1, 3]. Fabricating biomimetic systems capable of spatially heterogeneous trans-wall transport would promise the spatiotemporal programming of fluid components for biomedical applications [4-7], such as nutrient delivery in artificial tissue constructs and disease modeling in organ-on-chips [8, 9].

To date, orchestrating such different trans-wall transports in synthetic channels remains underexplored and challenging. First, channel walls should be (1) ultrathin and semipermeable to allow efficient and selective transport of molecules and (2) self-adapt to pressure fluctuations during the liquid introduction or extraction. Soft walls are preferred over solid walls. Channels with such walls are complicated to build by conventional manufacturing, which typically involves membrane assembly, mold fabrication, substrate casting, and membrane connection to substrates with channel features [9, 10]. Encouragingly, the complex process can be simplified into one step by using the emerging embedded 3D printing technique. This technique applies two liquids as printing ink and matrix, where the ink is extruded within the matrix through a print nozzle. During and after the ink deposition, polymers or nanoparticles pre-dispersed in the ink and matrix will interact on the ink-matrix interface, generating channel-like chambers with liquid cores and self-assembled walls [11-30]. The walls can be soft, semipermeable, and ultrathin (less than 1 μm) to mimic the functions of biological soft tissue [16, 18, 19, 29, 30]. Second, to control trans-wall transport over different regions, channel walls are spatially functionalized. Such functionalization can be achieved by removing the matrix, after which self-assembled walls are exposed to the air, allowing further treatment within designated regions. Nevertheless, when isolated from the matrix, the self-assembled channels are too soft to retain their 3D-printed architectures at the designated locations [30]. Hence, reported channels are typically embedded within the matrix [16-28], only allowing overall homogeneous molecular exchange between the matrix and liquids inside [16-20, 25]. In these channels, liquid compositions are simply varied across the whole channel, rather than being adjusted by region-specific reactions to change with a spatiotemporal order.

Previously work has been conducted on the structural stabilization of self-assembled channels [20, 24, 28], [Nat. Commun., 11 1182 (2020)]. The homogeneous functionalization of channel walls has also been studied. [21], [Nat. Commun., 10, 1098 (2019)]. Additionally, the limited spatial control of liquid components without channels has been reported. [Nat. Commun., 13, 2372 (2020); Nat. Commun., 13, 4162 (2022)].

### SUMMARY OF THE INVENTION

According to the present invention a new approach is used to synthesize semipermeable soft channels with heterogeneous functions. More specifically, a vascular network-inspired fluidic system (referred to herein as VasFluidics) is introduced, whose channel walls can be modified to physiochemically adjust the fluid components spatiotemporally through trans-wall transport. Facilitated by embedded 3D printing, channels with ultrasoft, thin (1-2 μm), and semipermeable walls are fabricated. The walls are immobilized to a solid substrate, similar to soft tissues supported by bone tissues, to avoid damaging or translocating the printed configurations upon matrix removal.

Two polymer solutions are used as printing ink and matrix for 3D printing of the channels. In order to prepare the printing ink and printing matrix, purified deionized water, anionic polyacrylamide (APAM) with an average molecular weight ≥3,000,000 g mol⁻¹, chitosan (>400 mPa·s), acetic acid and sodium hydroxide (NaOH) are used. The chitosan is dissolved in water-diluted acetic acid, and the pH is adjusted with NaOH aqueous solution. APAM is dissolved in deionized water with gentle shaking overnight. A 1 wt % chitosan solution (pH≈5-6) is used as the printing ink, and 1 wt % APAM solution (pH≈7) is used as the printing matrix.

After the self-assembly of channel walls, the matrix is removed. The matrix removal provides access to the channel to localize the reactions between channels and fluids, for instance, by confining solutions outside a specific channel for local reagent delivery, or by immobilizing a local channel wall with enzymes to alter the flow of molecules through the cell walls. With these approaches, the trans-wall molecules vary among different regions, facilitating the VasFluidics-based simulation of glucose absorption and metabolism in vascular networks. The fluidic system is potentially exploited to replicate biomolecule synthesis and biofluid dynamics in-vivo, serving as a platform for drug discovery and tissue engineering.

A 3D printer with a customized print nozzle connected to a syringe via PTFE tubing is used to create the channels. The syringe is prefilled with chitosan printing ink and is mounted on a syringe pump. Petri dishes or some other platforms are used to hold the printing matrix during the printing process, which is carried out at room temperature.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1A is a schematic illustration of the setup for a liquid-in-liquid 3D printing process to produce channels with self-assembled walls according to the present invention and FIG. 1B is an illustration of the self-assembly process of the channel walls on a liquid interface;

FIG. 2A is schematic illustration showing the printing and the self-assembly process of the channels, FIG. 2B is a confocal laser scanning microscope image and a scanning electron microscope image showing self-assembled channels with hollow cores and thin walls, FIG. 2C are a series of photographs showing how the soft and elastic channel walls deform under external force and resume their original shape upon removal of the force, FIG. 2D are photographs showing arbitrary 3D architectures for the printed channels, FIG. 2E shows the effect of the removal of the matrix and the infusion of liquids into the channels and FIG. 2F is a time series of optical images showing that the intracavitary volume of the channel can alter in response to the changed liquid volume inside the channel;

FIG. 3 is a schematic illustration of a syringe pump connected with a customized pipet tip-based print nozzle of a 3D printer to print the channels of the present invention;

FIG. 4A is a graph of the viscosity of chitosan, an APAM aqueous solutions, FIG. 4B is a graph of the shear strain against shear rate for APAM solutions and FIG. 4C shows graphs of elastic and viscous moduli as a function of the oscillatory shear stress for APAM solutions;

FIG. 5 shows the chemical structure of anionic APAM and chitosan;

FIG. 6 is a series of confocal scanning microscope images showing aggregation of polymers on the interface between APAM and chitosan solutions;

FIG. 7A shows a printed chamber with a formless APAM/chitosan wall, marked as hollow circles, FIG. 7B shows a printed channel-like chamber with a smooth APAM/chitosan wall, marked as filled circles and FIG. 7C shows chitosan and APAM concentration profiles for printing the chambers in FIGS. 7A and B;

FIG. 8A is a chart of the thickness of hydrated and freeze-dried membrane walls when applying APAM matrices with different concentrations, FIG. 8B is a chart of the thicknesses of hydrated and freeze-dried membrane walls with different self-assembly times and FIG. 8C is a chart of the thicknesses of freeze-dried membrane walls when applying chitosan ink with different pH:

FIG. 9A is a chart showing Young's modulus of membranous channel walls with different thicknesses and FIG. 9B shows Young's modulus of membranous channel walls under different solutions;

FIG. 10A is a series of photos showing self-healing of membranes after being punctured by a sharp needle, FIG. 10B is a series of photos showing that new branches can be added to an established chamber, resulting from the self-healing properties of the membranous walls and FIG. 10C shows the feasibility of building new bridges between two separate chambers or cutting established bridges, due to the self-healing properties of membranous walls;

FIG. 11A is an illustration of the printing of a channel, FIG. 11B shows the relationship between printing ink flow rate F (μL s⁻¹), print speed P (mm s⁻¹), and the cross-sectional area a (mm²) of the printed channel and FIG. 11C is a series of confocal laser scanning microscope images showing cross sections of channels printed with different printing parameters;

FIG. 12A shows the morphologies of the channel cross-sections approximated as parts of a circle with a radius of r and where the cross-sectional area, the height, the maximum width, the length of the APAM/chitosan membrane part and the length of the channel attached to the substrate are defined as a, h, w, m and s, respectively, and FIG. 12B shows the relationships between m (or w, s, h) and a;

FIG. 13A presents a series of confocal microscope images of channels with different initial cross-sectional areas (a₀) observed after printing and FIG. 13B shows graphs of the influence of self-assembly time (Tₘₐ) on morphological parameters of cross-sections;

FIG. 14A is a picture of a printing nozzle with a stainless-steel needle as its nozzle tip, FIG. 14B is a printed channel with a width of around 200 μm and FIG. 14C presents images showing cross sections of 3 different sized channels printed with the stainless-steel nozzle;

FIG. 15A shows the removal of a APAM printing matrix and chitosan printing ink after the self-assembly of printed channels using transfer pipettes or pipette tips to allow gentle removal and FIG. 15B shows continuous perfusion of the channel with deionized water to remove the chitosan ink inside;

FIG. 16A shows the refreshment of liquids outside the channel and FIG. 16B shows the refreshment of liquids inside the channel;

FIG. 17A shows a series of photos of liquid perfusion into a channel until the channel walls detach from the substrate under a certain liquid perfusion rate, FIG. 17B presents a series of photos showing perfusion into a large channel which can tolerate a high liquid perfusion rate and FIG. 17C show a chart of maximum flow rates for 50-60 mm long straight channels with different widths, above which the channel walls will detach from the substrate;

FIG. 18A is a picture of a channel being punctured with a sharp needle and FIG. 18B shows that the channel does not self-heal;

FIG. 19 is a fitted curve based on a shape factor function;

FIG. 20A is a set of fluorescence microscope images showing membrane selectivity for different-sized FITC-Dex molecules, FIG. 20B presents fluorescence microscope images showing the trans-wall transport of FITC-Dex10k under hypersaline, acidic or alkaline environment, FIG. 20C is a schematic of localized trans-wall exchange between liquids inside and the solution deposited outside, FIG. 20D shows spatiotemporal regulation of fluid components via the localized trans-wall introduction and extraction and FIG. 20E shows temporal regulation of methylene blue (MB) concentration inside the channel via localized trans-wall MB transport;

FIG. 21 shows a series of images of the deposition of solutions on or next to the channel;

FIG. 22A is a graph of the absorbance of chitosan, APAM, and methylene blue (MB) solutions, FIG. 22B is a graph of the absorbance of liquids inside a channel after depositing a methylene blue solution or a water solution on the channel and FIG. 22C is a graph of methylene blue concentrations in deionized water versus absorbance under a 662 nm wavelength light;

FIG. 23 is an image and graph showing that an MB concentration inside channel can be maintained above a certain value by introducing MB solutions repeatedly;

FIG. 24A is a schematic drawing showing the localized immobilization of functional materials on channel walls by attaching solutions to the channel and FIG. 24B shows a schematic and fluorescence microscope images of spatially arranged immobilization of two enzymes on channel walls;

FIG. 25A shows an enzyme-coated channel under a bright field, FIG. 25B shows the enzyme-coated channel under an FITC channel field in order to view FITC-HRP-coated regions, FIG. 25C shows the enzyme-coated channel under a RhB channel field in order to view RhB-GOx-coated regions and FIG. 25D shows RhB-GOx-coated regions for relative fluorescence intensity analysis;

FIG. 26A is a schematic of a vascular network-shaped VasFluidic device with 4 downstream regions immobilized with enzymes and 4 upstream regions taking in dyes via trans-wall transfer and FIG. 26B shows photographs of a corresponding VasFluidic channel being immobilized with fluorescence labeled enzymes and having fluorescence dyes introduced, which are visualized under a 405 nm light;

FIG. 27A shows images of a VasFluidic channel with regions for localized dye introduction and enzyme immobilization and FIG. 27B shows images of another VasFluidic channel with different regions for localized dye introduction and enzyme immobilization;

FIG. 28A is a schematic showing a cascade process of glucose absorption, glucose degradation, and carbon dioxide (CO₂) exhalation in in-vivo vascular networks, FIG. 28B is a schematic showing VasFluidic channels with compartmentalized functional domains, which enable glucose absorption, glucose degradation, and CO₂ exhalation, respectively, FIG. 28C is a schematic illustration of an experimental result showing the upstream channel selectively taking in glucose from a solution mixture of starch and glucose, FIG. 28D is a schematic illustration of an experimental result showing the glucose degradation in the enzyme-coated midstream regions and FIG. 28E is a schematic illustration of an experimental result showing the CO₂ exhalation via the trans-wall transport in downstream channels;

FIG. 29A shows optical and corresponding fluorescence microscope images of GOx-coated channels perfused with aqueous solutions of glucose and Amplex Red as a control, and FIG. 29B shows an HRP-coated channel perfused with aqueous solutions of glucose and Amplex Red as a control;

FIG. 30A is a photograph of a setup for detecting carbon dioxide (CO₂) exhaled via trans-wall transport where the channel is in an enclosed space and FIG. 30B shows details around the channel outlet, where liquids and gas from the outlet can be expelled to the outer environment;

FIG. 31A shows a series of images that illustrate that liquids cannot be injected in the dried channel and FIG. 31B shows a series of images that illustrate that the dried channel cannot be restored to its original structure even after re-hydration; and

FIG. 32 shows a series of images that illustrate the storage of a channel for 7 days by keeping the channel walls hydrated.

### DETAILED DESCRIPTION OF THE INVENTION

The present invention provides a method and apparatus to synthesize semipermeable soft channels with heterogeneous functions. These channels can be modified to adjust the transport of fluid components spatiotemporally.

Fabrication of Channels with Vascular Tissue-Like Soft Walls

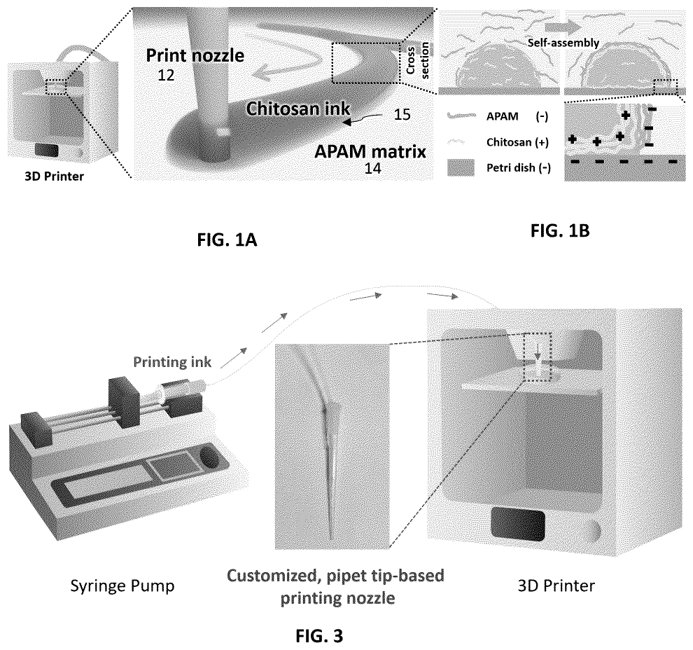

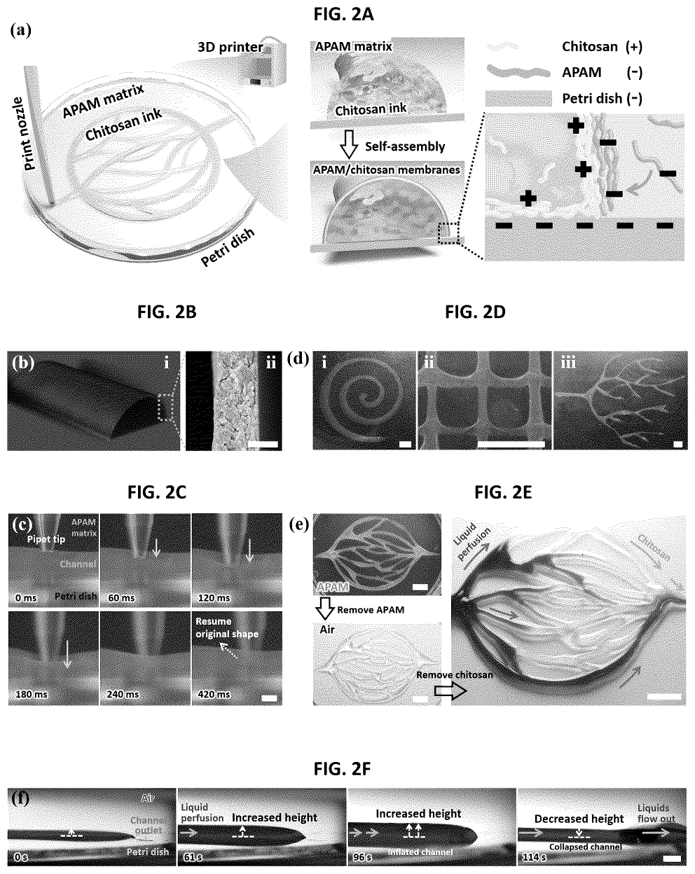

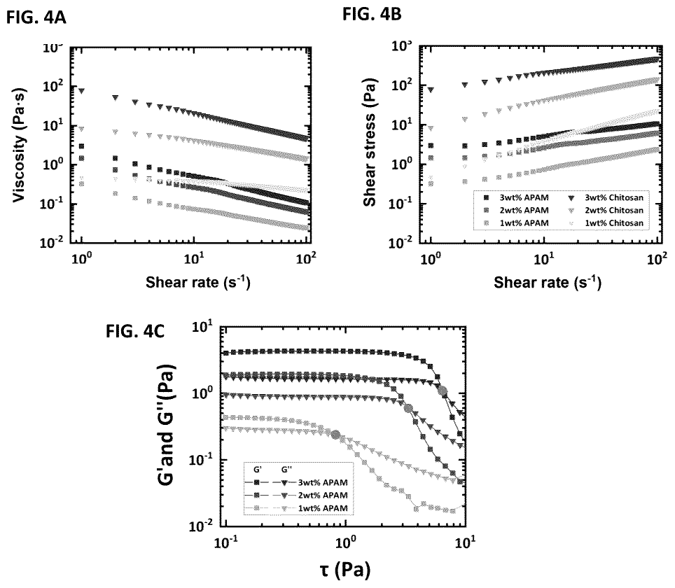

Embedded 3D printing is utilized to build channels with self-assembled soft membranous walls. Aqueous solutions of anionic polyacrylamide (APAM) and chitosan are used as a printing matrix and ink, respectively. A customized print nozzle 12 is translated under the APAM matrix 14 to deposit chitosan ink 15 onto the bottom of a Petri dish 16 or similar platform, similar to writing with a pen on paper (FIG. 1A, FIG. 2A and FIG. 3). Both chitosan ink and the APAM matrix are shear-thinning liquids, facilitating the controllable ink extrusion and the structural stabilization of deposited inks [31, 32] (FIG. 4).

FIGS. 4A-4C show the rheological properties of chitosan and APAM aqueous solutions. FIG. 4A shows viscosity and FIG. 4B shows shear strain against shear rate for 3 wt % APAM solution, 2 wt % APAM solution, 1 wt % APAM solution, 3 wt % chitosan solution, 2 wt % chitosan solution and 1 wt % chitosan solution, respectively. The shear rate is set from 100 to 102, suitable for extrusion scenarios. FIG. 4C shows the elastic, G′, and viscous, G″ moduli as a function of the oscillatory shear stress for APAM solutions with different concentrations at a frequency of 1 Hz. The determined yield stress values are circled in blue for each solution.

The chitosan printing inks are shear-thinning with zero-shear viscosities higher than 0.5 Pa·s, as shown in FIG. 4A). The ink with shear-thinning property can be controllably extruded from the nozzle [13, 32], since the viscosity decreases under increased shear force. The ink with appropriate viscosities can be extruded into threads instead of breaking them up into droplets during ink deposition [13, 44]. In the present invention, chitosan/APAM complexes self-assemble on the ink-matrix interface, locking chitosan polymers inside before they spread around.

The APAM matrix 14 is a shear-thinning and viscoelastic liquid, as demonstrated in FIGS. 4B and 4C. The shear-thinning matrix with a low-yielding stress (≤10 Pa) allows the print nozzle to move freely during printing [13]. In addition, the elastic modulus G′ of the matrix 14 is higher than the viscous modulus G″ at low shear stress; hence, the matrix is more solid-like. The solid-like matrix can facilitate the stabilization of printed structures after ink deposition [13, 45]

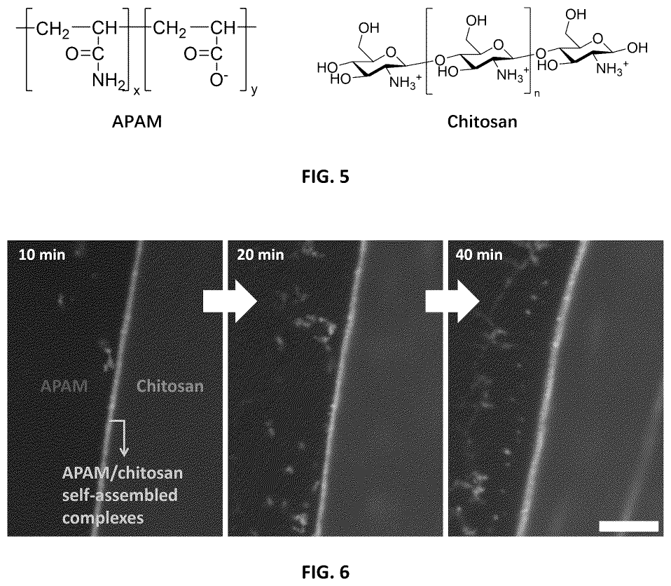

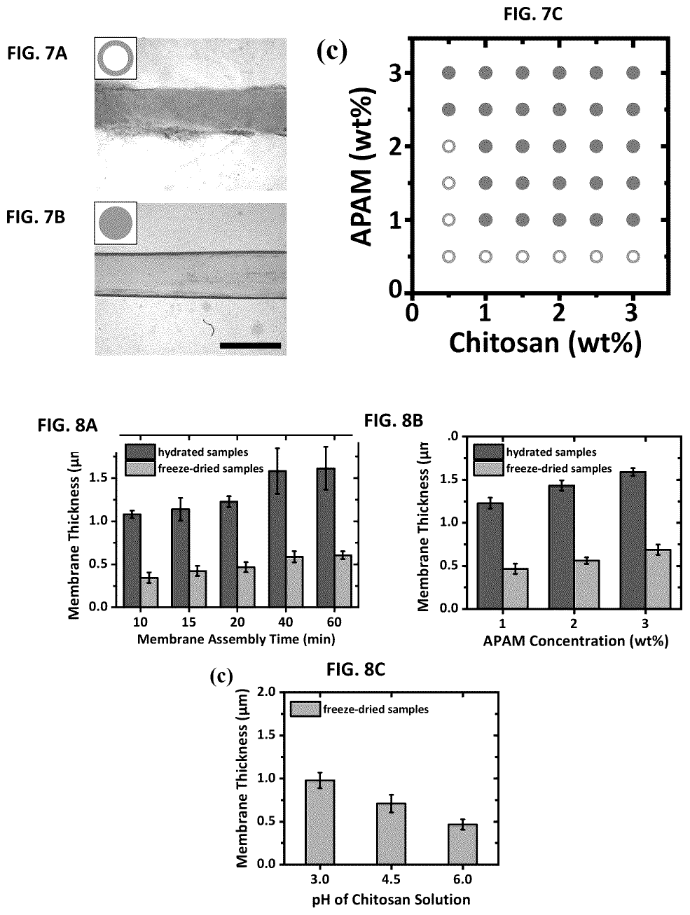

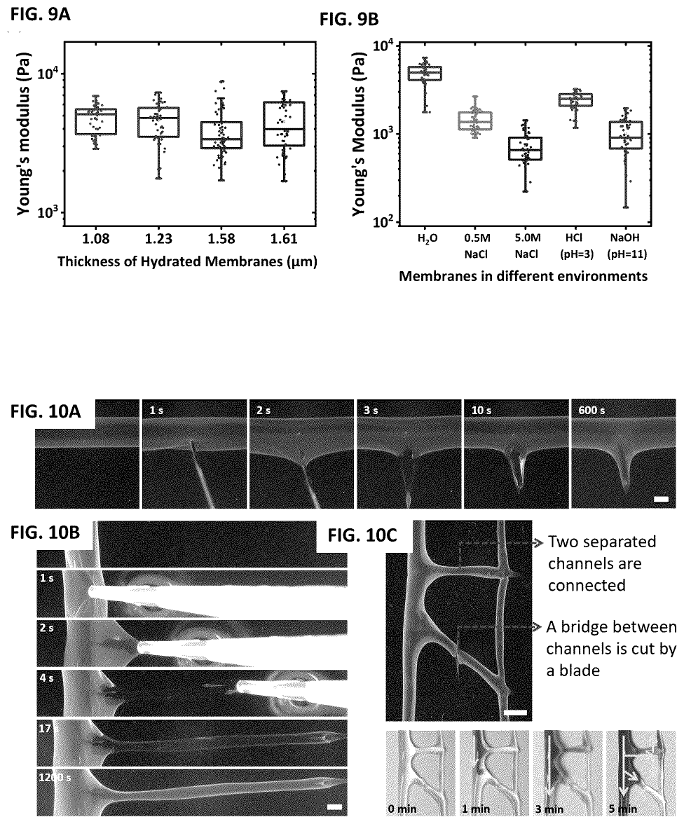

After the ink deposition, coacervates self-assemble on the interface between the ink and matrix, where coacervates are polymer complexes of APAM and chitosan polymers. Specifically, APAM contains negatively charged groups of carboxylic acid, and chitosan contains positively charged amine groups (FIG. 5). The APAM can attract chitosan under electrostatic forces, forming APAM/chitosan coacervates on the ink-matrix interface (FIG. 6). The coacervates aggregate into dense and thin membranes when applying appropriate concentrations of chitosan and APAM (FIG. 2B and FIG. 7B). During the self-assembly, some chitosan polymers are electrostatically attracted by the surface of the Petri dish, which carries negative charges with a charge density of −1.50±0.36 μC cm⁻². As a result, the self-assembled membranes adhere to the surface of the Petri dish, serving as walls of channel-like hollow chambers (FIG. 3). The thickness of the membranous wall is adjustable from 1 μm to around 2 μm by changing the polymer concentrations, the time, and the pH during membrane assembly (FIG. 8). The thickness is comparable to that of capillary walls in the human body, which are around 1 μm [1, 3]. Moreover, the self-assembled membranes are soft and elastic, similar to biological soft tissues. Moreover, the self-assembled membranes are soft and elastic with Young's modulus of 1-9 kPa (FIG. 9A), similar to that of some biological soft tissues, such as skin, spleen, and pancreas [33]. Thus, the channel-like chamber can deform under external force and resume their original shape upon removal of the force (FIG. 2C). The membranes can be even softer in saline, acid, and alkaline conditions (FIG. 9B). The flexibility of the membranes is presumably attributed to the long polymer chains in high-molecular chitosan and APAM. Compared to short-chained polymers, long-chained polymers form membranes with more chain entanglements, which endows the formed membranes with better mechanical strength [34, 35]. Moreover, the chamber walls can heal themselves. Once the walls are punctured, chitosan ink inside the chamber can react with the APAM matrix outside to generate new chitosan/APAM complexes to “heal” the walls (FIG. 10).

FIGS. 7A-7C show the results of suitable conditions for printing channel-like chambers, where FIG. 7A shows printed chamber with formless APAM/chitosan wall, marked as hollow circles. FIG. 7B shows printed channel-like chamber with a smooth APAM/chitosan wall, marked as filled circles. The scale bar is 1 mm. FIG. 7C shows chitosan and APAM concentration profiles for printing the chambers shown in FIGS. 7A and B.

FIGS. 8A-8C show thickness of hydrated or freeze-dried channel membranous walls under different conditions. Measurements of hydrated membrane walls may more closely represent their thicknesses as the channels are infused with liquids during operation. FIG. 8A shows the thicknesses of membrane walls when applying APAM matrix with different concentrations. 1 wt % chitosan solution (pH≈6) is used to interact with APAM solution (pH≈7) for the interfacial self-assembly of membranes. The duration for self-assembly is 20 min. FIG. 8B shows the thicknesses of membrane walls with different self-assembly times. The assembly starts when the APAM solution (1 wt %, pH≈7) contacts chitosan solution (1 wt %, pH≈6). The assembly ends by removing the APAM solution. FIG. 8C shows the thicknesses of membrane walls when applying chitosan ink with different pH. 1 wt % chitosan solution is used to interact with APAM solution (1 wt %, pH≈7) for membrane assembly. The duration for membrane assembly is 20 min.

FIG. 9A shows the Young's modulus of membranous channel walls with different thicknesses. The membranes are immersed under water to stay hydrated during the measurement with an atomic force microscope. FIG. 9B shows the Young's modulus of the membranous channel walls under different environments. Membranes are immersed in different solutions during the measurement with an atomic force microscope.

FIGS. 10A-10C present self-healing characteristics of membranous walls of printed chambers. FIG. 10A is a channel which self-heals after being punctured by a sharp needle. Once the membranous complexes are punctured, chitosan ink inside the chamber can react with APAM matrix outside to generate new chitosan/APAM assemblies. The coacervation time is 30 minutes for the chamber in the image labelled 0 s. The scale bar is 1 mm. FIG. 10B shows new branches can be added to an established chamber, resulting from the self-healing properties of the membranous walls. The membrane assembly time is 30 minutes for the chamber in the image labelled 0 s. The scale bar is 1 mm. FIG. 10C illustrates the feasibility of building new bridges between two separate chambers or to cut established bridges, due to the self-healing properties of membranous walls. Upon injecting dye liquids into the left-side channel, liquids can pass through the new bridge without leaking out, in comparison to the case when the channel has been truncated and liquid cannot flow through. The scale bar is 3 mm.

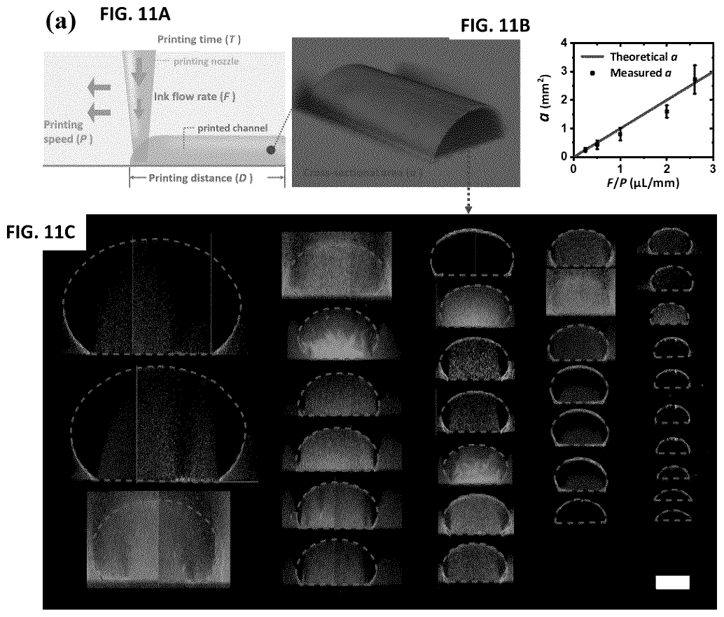

The printed channels can be engineered into various architectures with different sizes by adjusting printing parameters. The size of a single channel is adjustable by applying different printing speeds and ink flow rates (FIGS. 11-14). The size of printed channels is determined by the channel length and the area of cross-section perpendicular to the length. The channel length is determined by the printing distance D (unit: mm), as shown in FIG. 11A. The area of the cross-section perpendicular to the length is defined as a (mm²), which can be adjusted by changing the printing speed P (mm s⁻¹) and the flow rate of printing ink (F, μL s⁻¹). Specifically, printing speed P refers to the moving speed of the print nozzle 12, determined by the print distance (D, unit: mm) of the nozzle per unit of printing time (T, unit: s).

$$P = D / T \qquad ( 1 )$$

Ink flow rate F determines the ink volume (unit: mm³) being extruded from the print nozzle per unit of printing time T, which relates to the volume of the printed channel:

$$F \cdot T = D \cdot a \qquad ( 2 )$$

Equation 1 and Equation 2 determine the theoretical relationship between a, F, and P:

$$a = F / P \qquad ( 3 )$$

By measuring channels with different cross-sectional areas (FIG. 11C), the measured a match is found with Equation 3 (FIG. 11B). Therefore, a of printed channels is predictable with known F and P (Equation 3).

FIG. 11A is an illustration of the printing process, and FIG. 11B shows the relationship between printing ink flow rate F (μL s⁻¹), print speed P (mm s⁻¹) and the cross-sectional area a (mm²) of the printed channel, as defined in FIG. 11A. FIG. 11C is a series of confocal laser scanning microscope images showing cross sections of channels printed with different printing parameters. The printing ink is pre-mixed with 0.02 wt % FITC-Chitosan for visualization. Images are collected before removing the printing ink and matrix. Boundaries of the cross-sections are highlighted with red dotted lines. The scale bar is 500 μm.

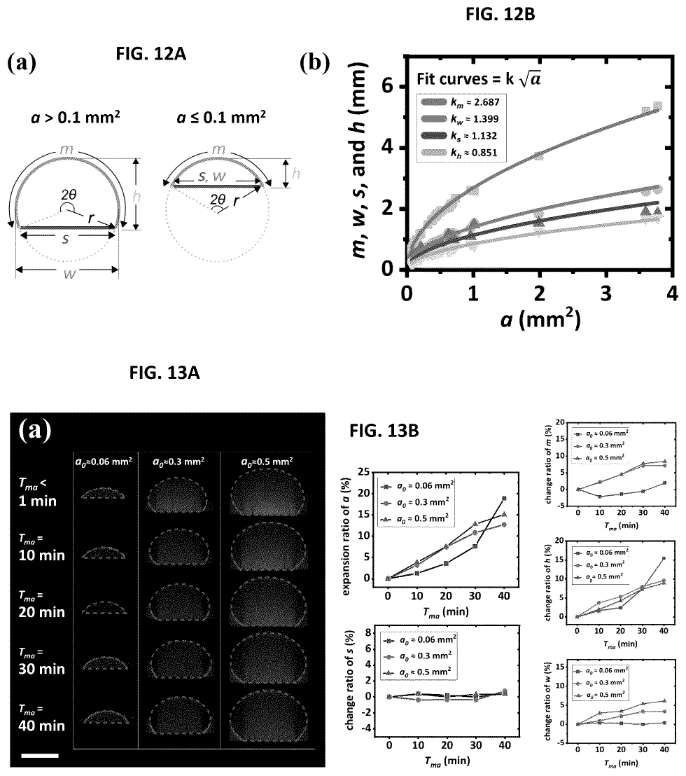

Morphological parameters of the cross-sections can be further estimated with known values of a. The morphologies of the channels' cross-sections can be approximated as parts of a circle, as shown in FIG. 12A. The height (h), the width (w), the length of the membrane part (m), and the length of the channel attached to the substrate(s) are measured by analyzing confocal laser scanning images of the channels' cross-sections as shown in FIG. 11C. In FIG. 12B the dots are measured data of m (blue), w (green), s (red), and h (orange), respectively. The solid lines are corresponding fit curves. Since parameters of lengths (m, w, s, h) should have an approximate square relationship with the area (a), the relation between h (or w, m, s) and a can be approximated to the following Equation 4, which fits the measured data well (FIG. 12B):

$$h ( or w , m , s ) = k √ a \qquad ( 4 )$$

where k is a constant. In this equation, w equals s with a constant value of 520-620 μm when a≤0.1 mm². The constant value relates to the size of the print nozzle tip (inner diameter=389.9±4.5 μm, external diameter=851.3±27.3 μm), and the average value of its inner and outer diameters is 620.6 μm. Hence, channels with smaller w are unavailable with such a large-sized print nozzle. Since the value of w can be directly measured under an optical microscope, a, h, and m can also be estimated with measured w when w is larger than 620 μm, as indicated in Equation 4.

Moreover, the volumes of channels expand with the prolonged assembly time of the membranes (Tₘₐ), which can lead to estimation errors in Equation 3 and Equation 4. The change ratios of a, h, m, w, s are present in FIG. 13A. The volumetric expansion may result from the unbalanced osmotic pressure between the printing ink and matrix. The influence of self-assembly time (Tₘₐ) on morphological parameters of cross-sections are shown in the graphs of FIG. 13B. The self-assembly starts when the printing process begins and is stopped by removing the APAM matrix. In FIG. 13A there are shown channels with different initial cross-sectional areas (a₀) as they are observed after printing. The scale bar is 500 μm. The cross-sectional area (a), the height (h), the maximum width (w), and the length of the APAM/chitosan membrane part (m) has a change ratio of less than 10% when Tₘₐ≤20 min. The length of that channel attached to the substrate(s) has a change of less than 1% with the increasing Tₘₐ.

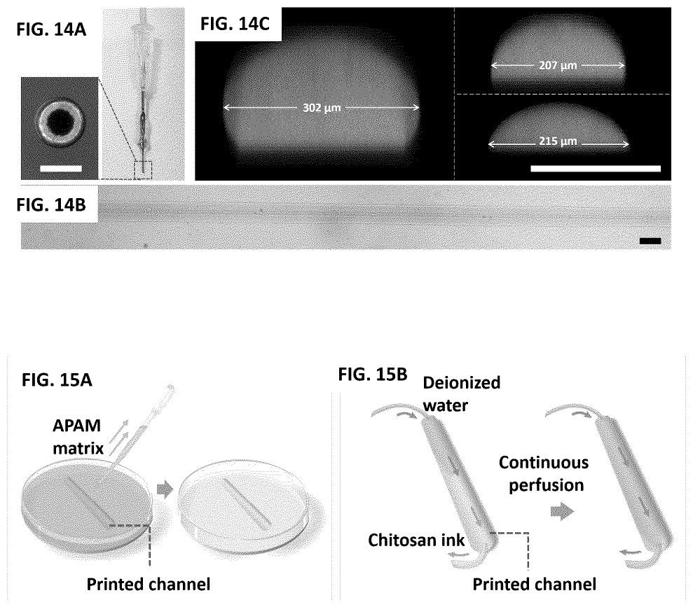

By utilizing the pipet tip-based nozzle tip, the channels obtained have a width (w) of around 500 μm-2 cm. Larger channels are not obtained due to the limitations of the setups. For instance, the printing speed cannot be decreased further with the current 3D printer, and the current pump cannot provide a higher pressure to extrude the viscous printing ink at a higher ink flow rate. Smaller channels can also be printed by using a printing nozzle tip with a smaller diameter, for instance, as presented in FIGS. 14A-14C. Thin channels with w around 200 μm are printed with a fine stainless-steel needle (inner diameter=129.5±1.5 μm, external diameter=245.9±1.7 μm). FIG. 14C shows cross sections of 3 different sized channels printed with the stainless-steel nozzle in FIG. 14A. The scale bars are 200 μm. Hence, although not realized by the present setups, the fabrication of even larger or smaller sized channels is possible with modified 3D printing setups.

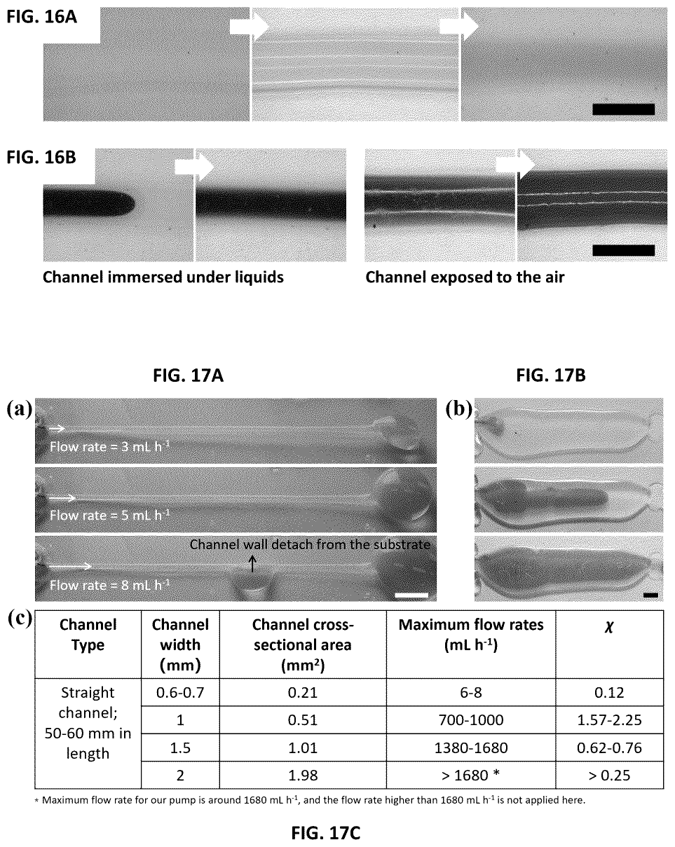

Various channels or chamber structures are obtained by further programming the printing path, including a spiral, a grid, a tree-like branch, and a vascular-shaped network (FIG. 2D, FIG. 2E). The chambers remain intact with designed architectures when the printing matrix and ink are removed (FIGS. 15A and 15B, and FIGS. 16A and 16B) Removal of the APAM printing matrix and chitosan printing ink after the self-assembly of printed channels can be achieved with the use of transfer pipettes or pipette tips to remove the APAM matrix gently as shown in FIG. 15A. As shown in FIG. 15B, the channel is then continuously perfused with deionized water to remove the chitosan ink inside. FIG. 16A shows the refreshment of liquids outside the channel and FIG. 16B shows the refreshment of liquids inside the channel, which is immersed under liquids or exposed to the air. The scale bars in the figure are 2 mm.

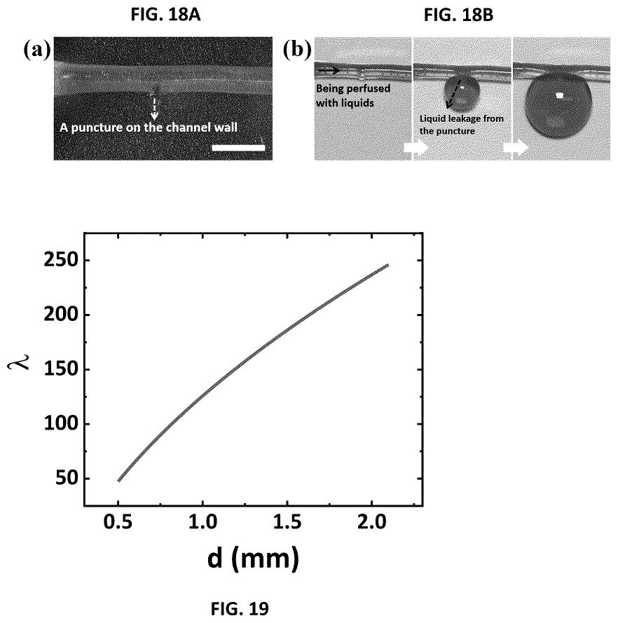

The printed structures can serve as fluidic channels when perfused with liquids inside (FIG. 2E). Due to the elasticity of the walls, the fluidic channels can self-adapt to the pressure fluctuations during the liquid perfusion. Before or during the perfusion, the channels can be inflated or collapsed to alter intracavitary volume in response to the changes in liquid volume inside, similar to the way in-vivo vessels change sizes under different blood pressure. Specifically, the channel with soft walls collapses when liquids inside flow out; by contrast, the channel inflates as the liquid volume inside increases (FIG. 2F). Notably, the walls will detach from the substrate when the flow rate of liquid inside exceeds the allowable flow rate. The range of allowable flow rates in different-sized channels is listed in FIG. 17C. The fluidic channel walls cannot self-heal after the removal of the printing ink and matrix (FIGS. 18A and 18B).

FIGS. 17A and 17B show liquid perfusion of straight channels with different widths. A 0.001-0.005 wt % rhodamine 6G aqueous solution is used as a perfusion liquid for clear visualization. Channel outlets are exposed to air for smooth flow of internal liquids. The channel widths are measured before removing the printing matrix, corresponding to w shown in FIG. 12A. FIG. 17A presents liquid perfusion into a channel with width of 610 μm. The channel walls detach from the substrate as the flow rate reaches about 8 mL h⁻¹. The scale bar is 5 mm. FIG. 17B presents liquid perfusion into a channel with a width larger than 1 cm. The liquid flow rate is larger than 20 mL h⁻¹. The scale bar is 5 mm. FIG. 17C is a table listing maximum flow rates for 50-60 mm long straight channels with different widths, above which the channel walls will detach from the substrate. Channels are perfused under certain flow rates for at least 1 min to observe if liquid will leak out of the channel, or the channel walls will detach from the substrate. χ is a governing dimensionless number related to allowable flow rates in different sized channels.

FIG. 18A shows a channel filled with water inside and exposed to the air. The channel wall is punctured with a sharp needle. The channel does not self-heal within 1 hour, which is confirmed by perfusing the channel with dye solutions, during which the dye leaks out from the puncture (FIG. 18B). The scale bar is 5 mm.

To guide the relationship between the maximum allowable flow rates and the channel size, we derive a governing dimensionless number χ based on the channel size. We approximate the channel cross section as a circle with a diameter of d. We model flow in the channel as a pressure driven pipe flow, where the inlet flow rate results in a flow pressure on the channel wall. The maximum flow rate is reached when the flow-induced shear pressure on the channel wall exceeds the bonding strength between the channel and the substrate. Under flow rate Q, the shear pressure on the channel wall is

$${τ}_{w a l l} = \frac{128 μ Q}{4 π {d}^{3}}$$

where μ is fluid viscosity. The flow induced axial pressure P leads to the expansion of the soft channel, with the diameter expanding from d₀ to d₀+Δd. For elastic materials, Δd correlates with d₀ via the Young's modulus E

$$Δ d = \frac{P}{E} {d}_{0}$$

At the maximum flow rate above which the channel will detach from the substrate, the shear stress on the channel wall reaches an equilibrium with the channel-substrate adhesion strength, which gives

$$\frac{128 μ {Q}_{max}}{4 {π ( {d}_{0} + Δ {d}_{max} )}^{3}} = {E}_{b o n d}$$

Assume E_{bond}=βE₀ and Δdₘₐₓ=ado, where α and β are prefactors, and E₀ is the unit adhesion strength between chitosan and Petri dish.

### Thus,

$$\frac{128 μ {Q}_{max}}{4 {π ( {d}_{0} + α {d}_{0} )}^{3}} = β {E}_{0}$$

$$or$$

$$\frac{128 μ {Q}_{max}}{4 π {β ( 1 + α )}^{3} {E}_{0} {d}_{0}^{3}} = 1$$

Note that the prefactors α and β could be constant, or dependent on the channel diameter d. In any case, a shape factor function is introduced for the channel λ(d)=β(1+α)³. Further, a dimensionless number is derived that measures the ratio between the flow-induced shear stress on the channel wall and the adhesion strength of the channel on the substrate

$$χ = \frac{128 μ Q}{4 π λ {E}_{0} {d}_{0}^{3}}$$

At the maximum flow rate of Q≈Qₘₐₓ (Q/Qₘₐₓ˜1), so

$$χ = \frac{128 μ Q}{4 π λ {E}_{0} {d}_{0}^{3}} ∼ 1$$

It is difficult to accurately estimate λ(d) and E₀, as the channel-substrate interaction is complex, and their contacting area could be composed of multiplayers of polymers. Nevertheless, a model case is next considered to show the dimensionless parameter χ is effective.
Model case: Considering a weak binding between the channel and the substrate (or between chitosan and Petri dish) with E₀=10 mPa, a shape factor function is chosen as

$$λ ( d ) = {A ( \frac{d}{{d}^{*}} )}^{γ} + B$$

where d* is a characteristic length scale.

The best fitting of the experimental data in FIG. 17C results in A=199.8, B=−143.2, d*=0.56 mm and γ=0.5. The fitted curve of the shape factor function of λ(d) is plotted in FIG. 19. In this way, χ is calculated under different flow conditions, as listed in FIG. 17C. Apparently, this results in O(0.1)≤χ≤O(1).

To further verify that χ guides the possible flow rates in VasFluidics channels of different sizes, the maximum flow rate is estimated for a channel with a width of 1.2 mm. The calculated maximum flow rate (924 mL h⁻¹) with χ=1 is close to the experimental value (1100-1300 mL h⁻¹), below which the channel wall remains intact, with no liquid leakage.

As noted above, during the the printing and the self-assembly process of channels the print nozzle 12 is translated within anionic polyacrylamide (APAM) matrix 14 to deposit chitosan ink against the bottom surface of platform or Petri dish 16. Driven by the electrostatic forces between the chitosan, APAM matrix, and the Petri dish carrying negative charges, channel-like chambers are generated with self-assembled chitosan/APAM membrane walls, which are attached to the Petri dish surface. The confocal laser scanning microscope image of FIG. 2B(i) shows the self-assembled chambers or channels with hollow cores and thin walls. A mixture of 0.02 wt % fluorescein isothiocyanate-labeled chitosan (FITC-chitosan) in the chitosan ink is used for visualization. FIG. 2B(ii) is a scanning electron microscope image showing the ultrathin and dense self-assembled walls. The scale bar is 500 nm. FIG. 2C shows a series of images of soft and elastic channel walls deformed under external force and resuming their original shape upon removal of the force. The external force is applied by using a pipet tip. The scale bar is 1 mm. FIG. 2D shows photographs of 3D-printed channels with arbitrary architectures, including (i) a spiral-shaped channel, (ii) a grid-shaped channel, and (iii) a branched network. Scale bars here are 5 mm. FIG. 2E shows the removal of the matrix and infusion of liquids into a vascular network-shaped channel. The channel remains intact during the removal of the matrix-ink interfaces and is exposed to the air when infused with rhodamine B (RhB, a red dye) aqueous solution. The scale bar is 1 cm. This is used to mimic blood vessels, and the infusion of red dye into the channel emphasizes this function. FIG. 2F is a time-series of optical images showing that the intracavitary volume of the channel can change in response to a change in the liquid volume inside. The height of the channel increases from 780 μm to 1560 μm when the liquid perfusion rate increases from 0 mL h⁻¹ to 3 mL h⁻¹. The height decreases to 970 μm when liquids inside partially flows out of the channel. The liquid for perfusion is RhB aqueous solution. The scale bar is 2 mm.

### Localized Trans-Wall Transport of Specific Molecules

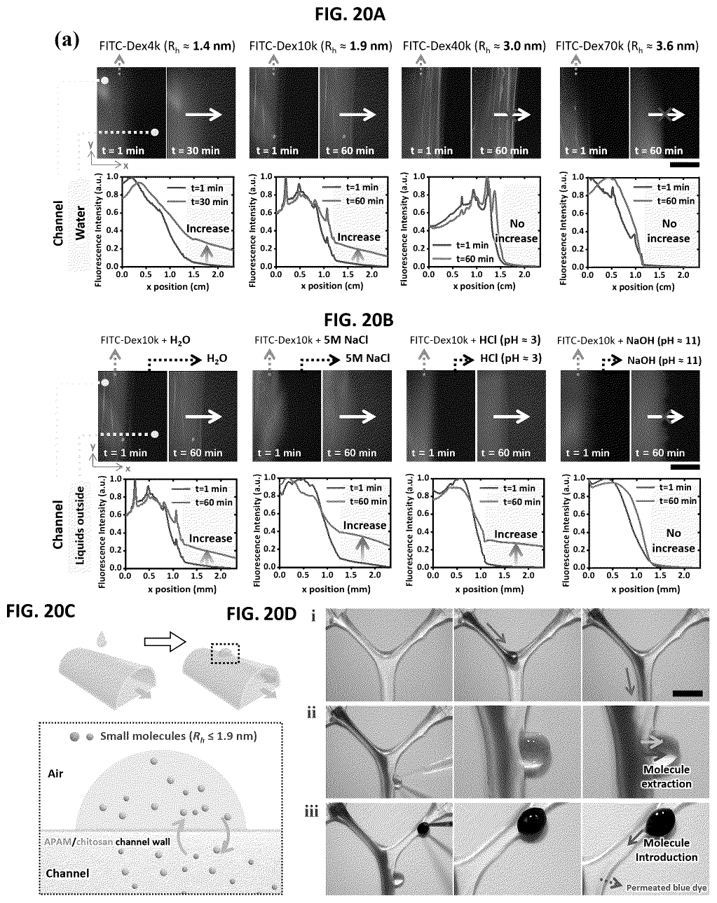

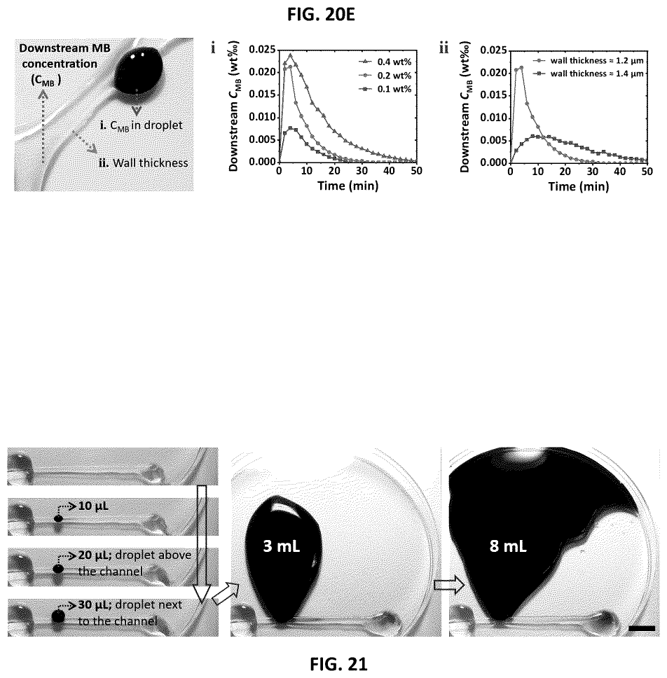

Similar to blood vessel walls, walls of the printed channels have selective permeability. The selective trans-wall transport is visualized with aqueous solutions of fluorescent molecules (FIG. 20A). Molecules with hydrodynamic radii (Rₕ) less than or equal to 1.9 nm can penetrate the wall, whereas molecules with a large Rₕ (≥3.0 nm) cannot. The dimensions of some of the solutes used in this investigation are shown in Table 1 below. Such size-selectivity indicates that the channel walls can block various possible contaminants from entering channels, such as floating or suspended solids, microorganisms, and even viruses (the minor diameter of viruses is 20-30 nm). The permeability of channel walls varies under different conditions; for example, it increases in saline and acid environments, and decreases in alkaline environments (FIG. 20B).

Substances with a radius or hydrodynamic radius (Rₕ) larger than 3.0 nm cannot pass through the membrane wall, while small-sized substances (Rₕ≤1.9 nm) can pass through.

TABLE 1
Dimensions of different substances.

| | | Can(√) or |
|---|---|---|
| | | cannot(x) pass |
| | | through walls |
| Substances | Dimensions | of VasFluidics |
| Fluorescein sodium salt | Rₕ ≈ 0.5 nm [37] | √ |
| R6G (Rhodamine 6G) | Rₕ ≈ 0.6 nm [38] | √ |
| FITC-Dex4k (Fluorescein | Rₕ ≈ 1.4 nm [39] | √ |
| isothiocyanate-labeled | | |
| dextran, 4,000 g mol⁻¹) | | |
| FITC-Dex10k (Fluorescein | Rₕ ≈ 1.9 nm [39] | √ |
| isothiocyanate-labeled | | |
| dextran, 10,000 g mol⁻¹) | | |
| FITC-Dex40k (Fluorescein | Rₕ ≈ 3.0 nm [39] | x |
| isothiocyanate-labeled | | |
| dextran, 40,000 g mol⁻¹) | | |
| FITC-Dex70k (Fluorescein | Rₕ ≈ 3.6 nm [39] | x |
| isothiocyanate-labeled | | |
| dextran, 70,000 g mol⁻¹) | | |
| GOx (Glucose oxidase) | Rₕ ≈ 4.5 nm [40] | x |
| HRP (Horseradish peroxidase) | Rₕ ≈ 4 nm [41] | x |
| Glucose (Dextrose) | Rₕ ≈ 0.4 nm [43] | √ |
| Starch (Maize starch) | Radius ≈ 2.5-10 μm [42] | x |

By localizing the trans-wall transport of specific molecules, liquid components within the channel can be spatiotemporally regulated (FIG. 20C and FIG. 20D). Solution of a few microliters to a few milliliters can be directly deposited on or next to the channel wall after removing the printing matrix and exposing the channel to air (FIG. 21). In FIG. 21, methylene blue (MB) aqueous solution is used for easy visualization, and a pipette tip is utilized to deposit the dye solution. The channel is infused with water inside at a flow rate of 2 mL h⁻¹ during the deposition of MB solutions. The channel is infused with water for at least 30 min before the solution is placed next to the channel. The scale bar is 1 cm. After depositing dye solution beside the channel, the solute molecules locally exchange between placed drops and liquids inside, varying compositions of the downstream liquids (FIG. 20C). To provide a proof-of-concept demonstration, a Y-shaped channel is printed, exposed to the air, and infused with aqueous solutions of dyes capable of penetrating the walls (FIG. 20D(i)). When depositing a water drop on the channel, local dyes inside are extracted and diffused into the droplet (FIG. 20D(ii)). Similarly, the introduction of methylene blue (MB, a blue dye) into the channel is localized by attaching an MB drop to the channel (FIG. 20D(iii). Since droplets can be deposited at random positions and times, the localized molecule introduction and extraction indicate the real-time regulation and monitoring of liquid components. For instance, at any time point, the concentration of downstream small molecules (Rₕ≤1.9 nm) in a specific branch can be increased or decreased by attaching water or solution droplets on channels; small molecules (Rₕ≤1.9 nm) at specific regions can be extracted to monitor whether intermediate products are generated as desired.

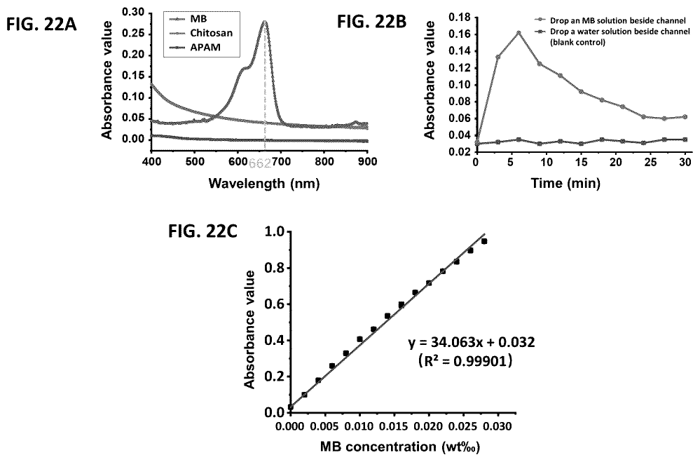

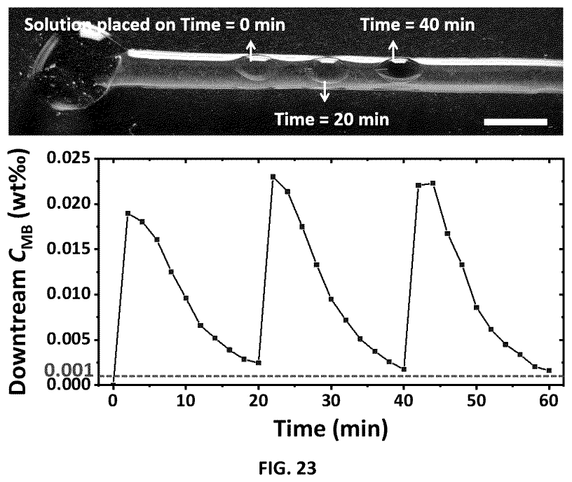

Moreover, as the trans-wall molecules penetrate gently, the alteration of downstream components through localized trans-wall transport can persist over a programmable period. For validation, the MB concentration of the internal flowing liquids was tracked, which varies continuously over 20 min after the deposit of a methylene blue (MB) droplet beside the upstream channel (FIG. 20E and FIG. 22). The concentration of introduced MB is temporally programmable. For instance, the duration is controlled by adjusting the wall thickness or placing MB droplets with different concentrations (FIG. 20E (i) and (ii)). The peak time of MB concentrations is also adjustable by applying channels with different wall thicknesses (FIG. 12E(ii)). Such temporally programmable introduction of new molecules can be exploited to control drug dynamics in in-vitro models, replicating or exploring human response to new drugs. For instance, by programming drug permeation into channels, the absorption of sustained-release drugs into bloodstream can be simulated. During the simulation, the peak time of drug concentration can be postponed when utilizing channels with thicker walls; the duration of effective drug concentration can be extended by repeatedly introducing drug inside, which is demonstrated with MB (FIG. 23). In FIG. 23, MB concentration inside channel is maintained above 0.001 wt % % by introducing 5 μL, 0.2 wt % MB solutions every 20 min.

FIG. 20A shows fluorescence microscope images that demonstrate the membrane selectivity for different-sized molecules. Aqueous solutions of fluorescent molecules with different hydrodynamic radii (Rₕ) are infused into channels at a flow rate of 0.5 mL h⁻¹. Channel walls under view are immersed under 200 μL deionized water. Fluorescein isothiocyanate-labeled dextran with a molecular weight of 4,000 g mol⁻¹ (FITC-Dex4k, Rₕ≈1.4 nm [39]) or 10,000 g mol⁻¹ (FITC-Dex10k, Rₕ≈1.9 nm [39]) are observed passing through the channel wall within 60 minutes. Trans-wall transport of fluorescein isothiocyanate-labeled dextran with a molecular weight of 40,000 g mol⁻¹ (FITC-Dex40k, Rₕ≈3.0 nm [39]) or 70,000 g mol⁻¹ (FITC-Dcx70k, Rₕ≈3.6 nm [39]) is not observed within 60 minutes. Normalized fluorescence intensities in images are analyzed with MATLAB. The scale bar is 1 mm. FIG. 20B presents fluorescence microscope images showing the trans-wall transport of FITC-Dex10k (Rₕ=1.9 nm) under hypersaline, acidic or alkaline environment. The permeability of channel walls increases under saline and acidic conditions, as more trans-wall FITC-Dex10k is observed within 60 min. The permeability of channel walls decreases with increasing pH, and FITC-Dex10k cannot cross the channel wall when increasing the pH to 11. The channel is infused with FITC-Dex solutions at a flow rate of 0.5 mL h⁻¹. Channel walls under view are exposed to 200 μL deionized water. Relative fluorescence intensities of different images in arbitrary units (a.u.) are analyzed with MATLAB. The scale bar is 1 mm. FIG. 20C shows the localized trans-wall exchange between liquids inside and the solution deposited outside. FIG. 20D shows spatiotemporal regulation of fluid components via the localized trans-wall introduction and extraction. As noted above, FIG. 20D (i) shows a Y-shaped channel perfused with R6G (red) and T/Thioflavin T (yellow) aqueous solutions, (ii) shows dyes at random positions and times that can be extracted by depositing one deionized water droplet next to the channel, (iii) shows Methylene blue (MB, a blue dye) introduced into the channel at random positions and times by placing a methylene blue (MB) droplet next to the channel. The scale bar is 1 cm. FIG. 20E shows temporal regulation of MB concentration inside the channel via localized trans-wall MB transport. The channel is perfused with deionized water at a flow rate of 3 mL h⁻¹. After placing a 5 μL MB droplet beside the channel, 1 cm downstream liquids inside are collected every 2 min to analyze the MB concentration inside channel. MB concentrations with different dynamics are presented when different concentrated MB droplets are placed beside the channel FIG. 20E(i) or when channels with different wall thicknesses are applied FIG. 20E(ii).

FIG. 22A shows the absorbance of APAM, chitosan, and methylene blue (MB) solutions. MB can be distinguished from the possible residual chitosan and APAM polymers after the removal of the printing ink and matrix. The 662 nm wavelength light is applied for the later detection of MB. FIG. 22B shows the absorbance of liquids inside the channels after depositing an MB solution or a water solution on the channel. The trans-wall MB can vary the absorbance of liquids inside channel. The channel is perfused with deionized water inside (flow rate=4 mL h⁻¹), and the downstream liquid is collected every 3 min for analyzing the absorbance. FIG. 22C shows that MB concentrations in deionized water can be estimated by analyzing absorbance. Absorbance values and MB concentrations have approximate linearity when MB concentration is lower than 0.03 wt ‰. The fitting function (red line) between MB concentrations (x) and absorbance value (y) is y=34.063x+0.032. The corresponding coefficient of determination R² is 0.99901.

### Local Immobilization of Enzymes on Channel Walls

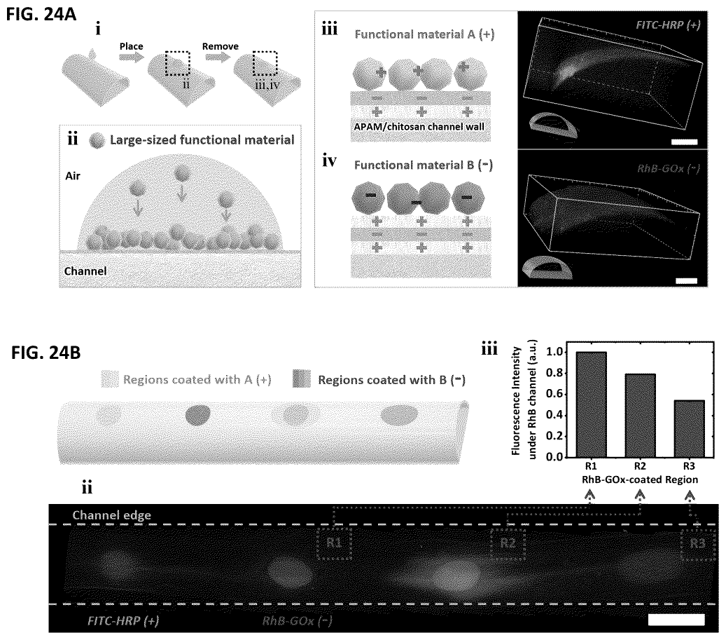

Besides physically allowing specific molecules to pass through, the walls can chemically alter fluid compositions when modified with functional materials. The functional materials should have large sizes (radius or Rₕ≥3.0 nm) and carry electrostatic charges, such as some polymers, particles, and proteins. When placing corresponding solutions outside the channels, these materials can be electrostatically attracted to the walls without penetration. As a result, the channel walls are modified with an extra layer of functional materials (FIG. 24A). Such a modification of the walls is demonstrated with glucose oxidase (GOx) enzyme and horseradish peroxidase (HRP) enzyme, both of which have Rₕ larger than 3.0 nm [40, 41] and cannot penetrate channel walls (Table 1). At a neutral pH (pH=6-8), GOx is negatively charged, and HRP is positively charged. Therefore, positively charged FITC-labelled HRP (FITC-HRP, green) can be attracted by the negatively charged APAM and immobilized on the channel wall (FIG. 24A(iii)); negatively charged and RhB-labelled GOx (RhB-GOx, red) can also be adsorbed onto the wall via layer-by-layer assembly [21, 36] (FIG. 24A(iv)).

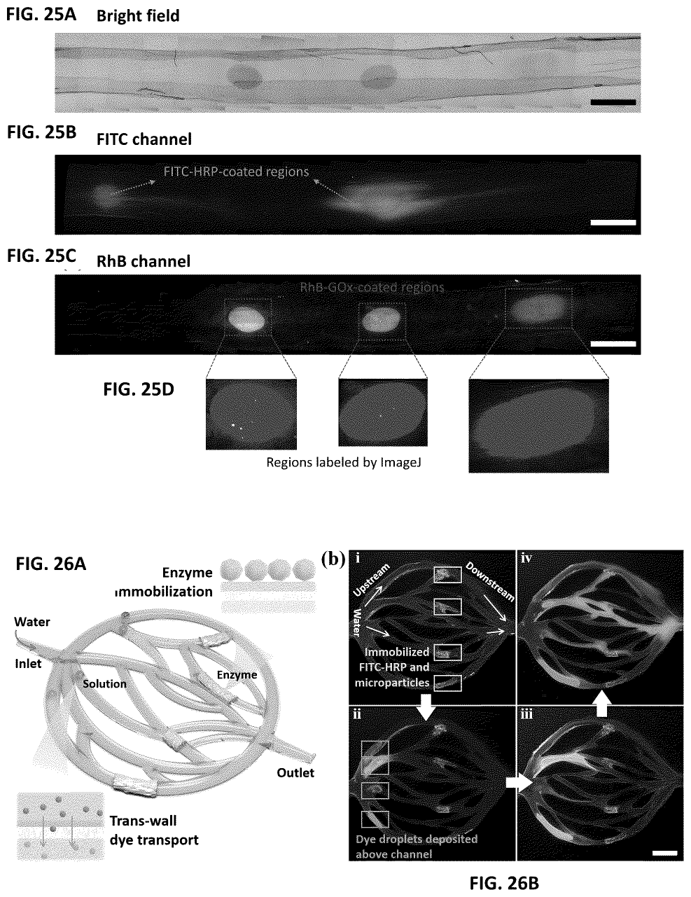

The extra-coating can be spatially distributed on a single channel with variable coating amounts, which is demonstrated with enzymes as an example. Different enzymes can be co-immobilized on the channel walls, separately or overlappingly (FIG. 24B). In FIG. 24B, a channel is modified with two RhB-GOx-coated regions, one HRP-coated region, and an RhB-GOx and FITC-HRP co-coated region. Among these regions, the immobilized enzyme amount can be varied, for instance, by treating local walls with different concentrations of enzyme solutions. Different fluorescence intensities are exhibited in regions treated with different concentrations of RhB-GOx solutions, showing that the immobilized enzyme amount is tunable (FIG. 24B(ii) and FIG. 25).

FIGS. 24A and 24B present schematic drawings and experimental results showing the localized immobilization of functional materials on channel walls by attaching solutions to the channel. In FIG. 24A, the large-sized solutes (radius or Rₕ≥3.0 nm) carrying electrostatic charges cannot penetrate membrane walls but can be electrostatically immobilized on the membranes. FIG. 24A(iii) and FIG. 24A(iv) are schematic drawings showing the immobilization of negatively or positively charged solutes on channel walls, and confocal laser scanning microscope images showing channel walls immobilized with the positively charged FITC-labeled horseradish peroxidase (FITC-HRP, green) or negatively charged RhB-labeled glucose oxidase (RhB-GOx, red). Scale bars are 200 μm. FIG. 24B(i) is a schematic drawing and FIG. 24B(ii) shows fluorescence microscope images of the spatially arranged immobilization of two enzymes on channel walls. RhB-GOx-coated regions are visualized under the RhB channel of the microscope, and FITC-HRP-coated regions are visualized under FITC channel of the microscope. Fluorescence images under the RhB channel and FITC channel are collected, respectively, and merged into one. To obtain the three RhB-GOx-coated regions, region R1 is treated with 0.5 μL, 10 mg mL⁻¹ RhB-GOx solution; region R2 is treated with 0.5 μL, 4 mg mL⁻¹ RhB-GOx solution; and region R3 is coated with 1 μL, 1 mg mL⁻¹ RhB-GOx solution. The left HRP-coated region is treated with 0.5 μL, 1 mg mL⁻¹ FITC-HRP aqueous solution, and the right is coated with 1 μL, 4 mg mL⁻¹ FITC-HRP aqueous solution. The scale bar is 2 mm. FIG. 24B(iii) shows that RhB-GOx-coated regions treated with different concentrated RhB-GOx solutions have different fluorescence intensities. The normalized fluorescence intensities are obtained by analyzing fluorescence microscope images under the RhB channel.

FIGS. 25A-25C show an enzyme-coated channel under bright field, FITC channel, and RhB channel. Fluorescence microscope images collected under the FITC channel and RhB channel show the regions coated with FITC-HRP and RhB-GOx, respectively. Scale bars are 2 mm. In FIG. 25D, fluorescence microscope images under the RhB channel are used to analyze the relative fluorescence intensity of different RhB-GOx-coated regions. RhB-GOx-coated regions are labeled red by ImageJ for analysis. These immobilizations with different spatial distribution and enzyme loading amounts result in the functional heterogeneity of channel walls. For instance, regions thickened with multiple coacervate layers can transport molecules across the wall at a slower rate; regions coated with functional materials, such as enzymes, can speed up chemical reactions inside channels.

### Spatially Arranged Physiochemical Reactions Between Fluids and VasFluidic Device

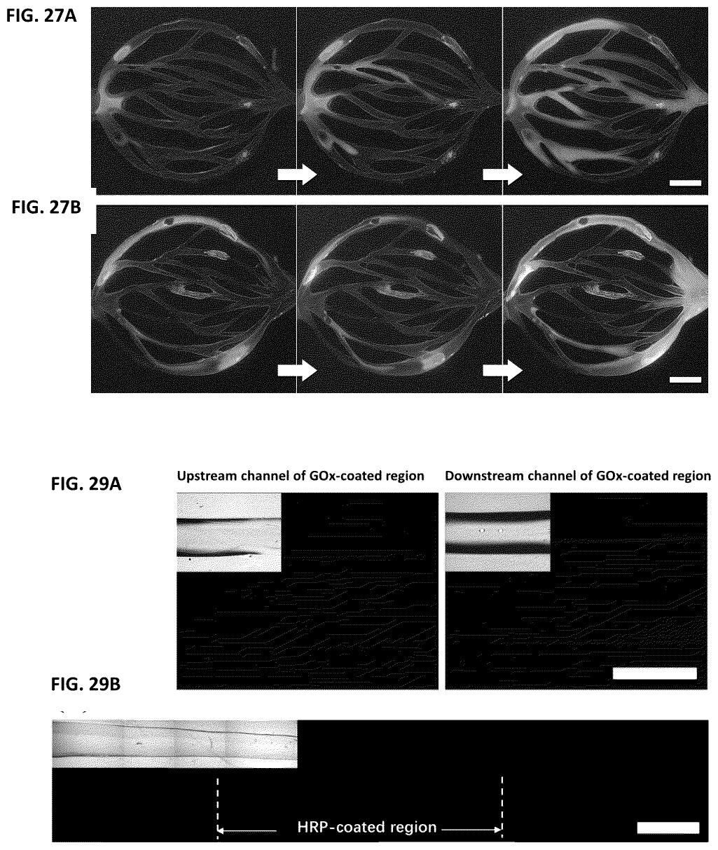

In the same VasFluidic device, different regions can be assigned simultaneously for both trans-wall transport and enzyme immobilization. As a demonstration, a VasFluidic channel was prepared in which 4 downstream regions were immobilized with enzymes, and 4 upstream regions were designated for dye introduction (FIG. 26, FIG. 27). The walls of the 4 downstream regions are treated with a mixed solution of FITC-HRP and negatively charged green, fluorescent microparticles for enhanced fluorescence (FIG. 26B). The predetermined 4 upstream locations are attached with R6G (red) and fluorescein sodium fluorescein (green) solutions, penetrating the walls and modulating the fluid compositions in corresponding downstream channel branches. (FIG. 26B(ii-iv)) The location and number of regions for dye introduction (or enzyme immobilization) can be varied on demand, as shown in FIGS. 27A and B, wherein. optical images of 2 VasFluidic devices are shown, which are perfused with deionized water inside and pre-modified with FITC-HRP and green, fluorescent particles in the walls. The dye solutions are placed at different positions and pass through channel walls to change the fluid compositions in different channel branches. Scale bars are 1 cm.

FIG. 26A is a schematic of a vascular network-shaped VasFluidic device with 4 downstream regions immobilized with enzymes and 4 upstream regions taking in dyes via trans-wall transfer. Corresponding optical images of the VasFluidic device are also presented in FIG. 26B. A VasFluidic channel being perfused with water inside and exposed under 405 nm light. FIG. 26 B(i) shows 4 regions on the downstream channels coated with FITC-HRP and 1 μm negatively charged green, fluorescent particles. The fluorescent particles are used for enhancing the fluorescence in enzyme-immobilized regions. FIGS. 26B(ii-iv) show 4 upstream regions attached with dye solutions, where dye molecules are introduced into the channel to change the fluid compositions in different channel branches. The dyes are R6G (red) and fluorescein (green). The scale bar is 1 cm.

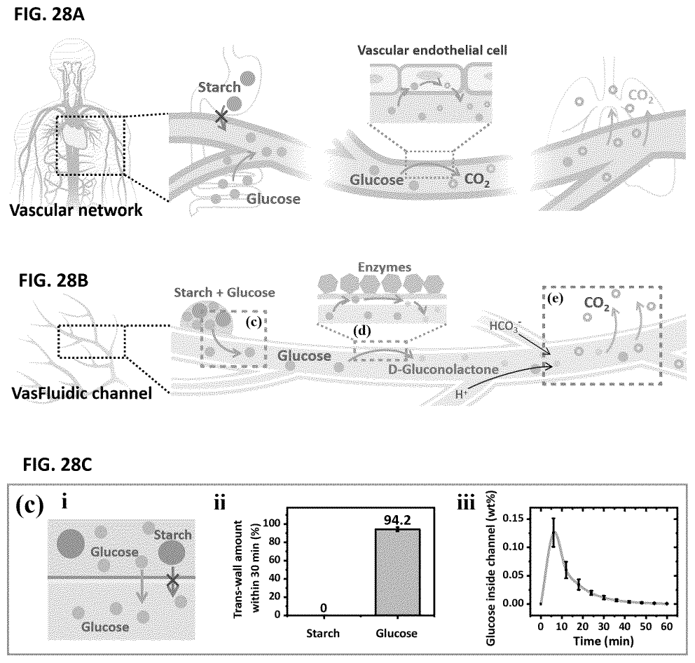

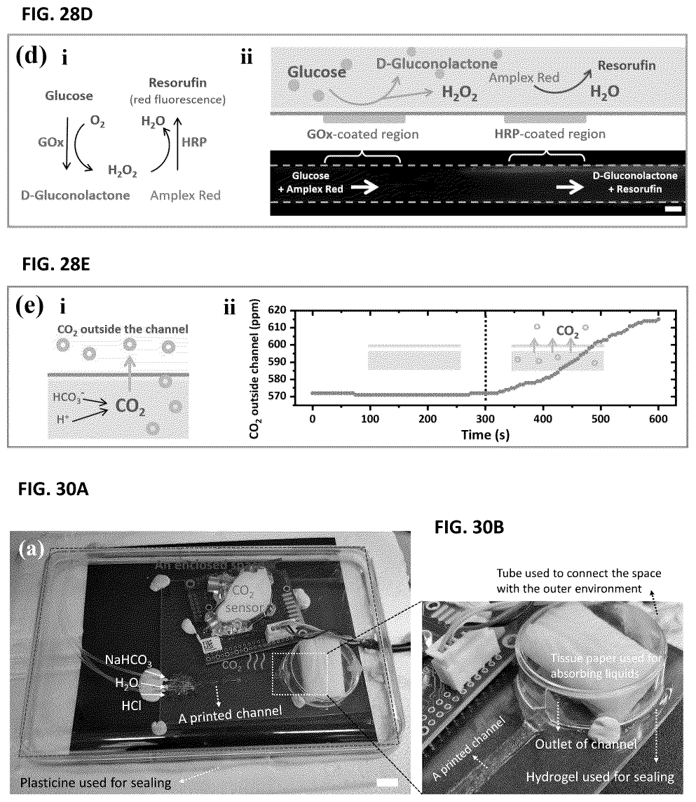

When functionalizing VasFluidic channels with compartmentalized domains, various region-specific reactions with fluids can proceed under spatiotemporal control. As a proof of concept, a VasFluidic channel was engineered for a multistep cascade reaction to simulate the control over glucose in the vascular network (FIG. 28A): In the vascular network, vessels in digestion organs do not directly take in starch before it is degraded into glucose. Absorbed glucose will be partially degraded by endothelial cells on vessel walls, during which carbon dioxide (CO₂) is produced. The cumulated CO₂ in the blood will finally escape through vessel walls and be partially exhaled by the lungs. A similar process is executed in a VasFluidic device (FIG. 28B): The upstream channel selectively takes in glucose from the attached droplets; the glucose is degraded into smaller molecules in the midstream channel by the action of pre-immobilized enzymes. CO₂ is further generated and exhaled from the permeable walls in the downstream channel.

Specifically, the upstream channel selectively intakes glucose (FIG. 28C). When a solution mixture of starch and glucose is deposited above the channel, the channel blocks starch (granules radius≈2.5-10 μm [42]) from the outside, as shown in FIG. 28C(i). In contrast, around 94% of glucose (Rₕ≈0.4 nm [43]) in the starch-glucose solution permeates into the channel within 30 min (FIG. 28C(ii)). During the glucose permeation, the downstream glucose concentration presents temporal fluctuation (FIG. 28C(iii)). The glucose variation is similar to that in the vascular network during food digestion, where blood glucose concentration increases first and then gradually decreases. Here, the glucose introduction is limited to around 1 hour to restrict the duration of the following glucose degradation (FIG. 28C(iii)).

The absorbed glucose is partially degraded while flowing through the midstream channel, in which two separated regions are immobilized with GOx and HRP, respectively (FIG. 28D). Since glucose can pass across membrane walls to meet enzymes on the external wall, the GOx-coated region oxidizes glucose into D-gluconolactone and hydrogen peroxide (H₂O₂), and the produced H₂O₂ is further converted into H₂O in the following HRP-coated region (FIG. 28D(i)). This bi-enzymatic cascade reaction can be indicated by Amplex Red, which is converted into resorufin to emit red fluorescence during the HRP-mediated H₂O₂ catalysis (FIG. 28D(ii)). The appearance of the red color is an important indicator of the success of the enzyme-mediated reaction. Notably, the red fluorescence is present only when fluids flow through the HRP-coated region, indicating region-specific HRP-mediated catalysis. As for channels immobilized with GOx or HRP only, the bi-enzymatic cascade reaction does not occur (FIGS. 29A & B). In particular, FIGS. 29A & B present optical and corresponding fluorescence microscope images of channels modified with GOx or HRP only as control groups, where the bi-enzymatic cascade reaction for glucose degradation is not detected. A GOx-coated channel is perfused with aqueous solutions of glucose and Amplex Red. During the perfusion, no fluorescence is observed in the upstream or downstream channel of the GOx-coated region. The HRP-coated channel is also perfused with aqueous solutions of glucose and Amplex Red. During the perfusion, no fluorescence is observed in that channel. Scale bars are 1 mm.

The glucose degradation is followed by downstream trans-wall emission of CO₂, similar to the CO₂ exhalation by lungs after nutrient absorption (FIG. 28E). Since CO₂ exhaled by lungs is generated from accumulated bicarbonate (HCO₃⁻) in blood, the downstream CO₂ is produced with sodium bicarbonate (NaHCO₃) and hydrochloric acid (HCl). NaHCO₃ and HCl are perfused and designed to meet in the downstream junction, as shown in FIG. 18B and FIG. 18E(i). Setups to detect the trans-wall CO₂ are presented in FIGS. 30A & B. The CO₂ concentration surrounding the channel remains unchanged when infusing the channel with HCl only. In FIGS. 30A & B the setups for detecting the CO₂ being exhaled via trans-wall transport. The channel is in an enclosed space. The channel is perfused with deionized water, sodium bicarbonate solution (NaHCO₃, pH≈9.7), and hydrochloric acid solution (HCl, PH≈4). All liquids are perfused with a flow rate of 0.7 mL h⁻¹. A CO₂ sensor is placed beside the channel. The sensor and the channel are sealed in a transparent enclosed space with a volume of around 400 cm³. The area of the channel walls exposed to the air is around 4 cm×4 mm. The outlet of the channel is sealed in FIG. 30B in another enclosed space connected with the outer environment. Liquids flowing out from the channel outlet can be absorbed by tissue paper, and gas from the outlet can be expelled to the outer environment. The scale bar is 1 cm. However, the CO₂ concentration increases when perfusing the channel with NaHCO₃ and HCl simultaneously; this is attributed to the trans-wall CO₂ escaping from the channel inside (FIG. 28E(ii)). By expelling CO₂ via trans-wall transport, the pressure, pH, and gas contents of the flowing fluids inside are regulated.

In the biomimetic VasFluidics device, fluid compositions are regulated by a program over space and time, via the various region-specific reactions (FIG. 28B-28E). The dynamics of fluid compositions in VasFluidics channels can be even more complex, for instance, by designing channels with complicated structures to connect several cascade fluid reactions in parallel.

FIG. 28A is a schematic showing a cascade process of glucose absorption, glucose degradation, and carbon dioxide (CO₂) exhalation in in-vivo vascular networks. FIG. 28B is a schematic showing VasFluidics with compartmentalized functional domains, which enable glucose absorption, glucose degradation, and CO₂ exhalation, respectively. FIG. 28C(i) is a schematic showing that the upstream channel selectively takes in glucose from a solution mixture of starch and glucose. The branch channel is perfused with deionized water at a flow rate of 1 ml L⁻¹. A 2 μL starch-glucose aqueous solution containing 20 wt % starch and 20 wt % glucose is attached to the upstream channel. Liquid samples are then collected in the 1 cm downstream channel every 6 min. By analyzing glucose and starch concentrations in collected samples with corresponding assay kits, respectively, the trans-wall amount of glucose and starch within 30 min (FIG. 28C(ii)) and the real-time glucose concentration of liquids inside the channel (FIG. 28C(iii)) can be derived. FIG. 28D(i) is a schematic showing an enzyme-mediated cascade reaction to decompose glucose, which can be visualized by a red fluorescence probe. FIG. 28D(ii) is a schematic and FIG. 28D(iii) shows fluorescence microscope images showing the midstream decomposition of glucose into D-gluconolactone. The midstream channel with a GOx-coated region and an HRP-coated region converts glucose and Amplex Red into D-gluconolactone and resorufin, respectively. The scale bar is 1 mm. FIG. 28E(i) is a schematic showing the downstream exhalation of CO₂ via trans-wall transport. The CO₂ is produced with sodium bicarbonate (NaHCO₃) and hydrochloric acid (HCl). FIG. 28E(ii) shows real-time CO₂ concentration outside the downstream channel. The CO₂ concentration remains unchanged when the channel is perfused with HCl aqueous solution only (0-300 s). The CO₂ concentration increases as the channel is perfused with HCl and NaHCO₃ aqueous solutions simultaneously (300-600 s).

Thus, a vascular network-inspired fluidic system (VasFluidics) with soft tissue-like membrane walls has been provided. The functions of VasFluidics channels can be modified to adjust spatially to react with fluids at compartmentalized domains, and thus are capable of regulating fluid compositions in a spatiotemporal manner. Facilitated by embedded 3D printing, membranous coacervates are self-assembled to form walls of fluidic channels. The walls are flexible, ultrathin, semipermeable, and immobilized to the Petri dish substrate to remain printed configurations during the removal of printing ink and matrix. By depositing solutions or immobilizing enzymes on separated regions of channel walls, VasFluidics channels are functionalized for different region-specific flow chemistry. Some regions physically allow specific molecules to pass across walls, while some chemically alter fluid compositions. Thus, the trans-wall molecules vary over different regions, resulting in the spatiotemporal variation of fluid compositions in VasFluidics channels. Such space- and time-varying fluid components are ubiquitous in natural fluidic systems but challenging to be implemented in existing synthetic fluidics. Hence, VasFluidics will extend the functions of the existing fluidic devices. The fast-evolving 3D printing may further push the envelope in the geometry complexity of VasFluidics devices, such as building ultra-fine channels with intricate organization, for replicating the flow in blood capillaries with a diameter of 7-9 μm. Overall, VasFluidics can pioneer complex fluid manipulation or even revolutionize the way fluid processing is achieved, which is applicable to areas including but not limited to biological fluid mechanics, biomolecule synthesis, and drug screening.

### Methods

Printing ink and printing matrix preparation. Purified deionized water (Direct-Q®5UV-R, Merck), anionic polyacrylamide (APAM, average molecular weight ≥3,000,000 g mol⁻¹, ≥85.0%, purchased from Hushi, China), chitosan (>400 mPa·s, purchased from Aladdin, China), acetic acid (Molecular weight (Mw)=60.05, ≥99.07%, purchased from Acros Organics, Belgium), sodium hydroxide (NaOH, Mw=40.00, 97%, purchased from Aladdin, China) were used for solutions preparation. Chitosan was dissolved in water-diluted acetic acid, and the pH was adjusted with NaOH aqueous solution. A PH meter (PH550 Benchtop PH Meter, Oakton) was used to prepare the chitosan solution with a given pH value. APAM was dissolved in deionized water with gentle shaking overnight. Unless otherwise specified, the chitosan printing ink was 1 wt % chitosan solution (pH≈5-6), and the APAM printing matrix was 1 wt % APAM solution (pH≈7). 2 wt % APAM matrix was used when printing the vascular network-shaped channel in FIG. 2E, FIG. 26B, and FIGS. 27A&B. Both chitosan and APAM solutions were used within three days after preparation. The rheological properties of the APAM and chitosan solutions were measured by a commercial rheometer (MCR 320, Anton Paar).

Embedded printing of VasFluidics channels. A commercially available 3D printer was used in all printing experiments (Ultimaker 2+, Netherlands). The customized print nozzle was one commercially available 0.5-10 μL pipet tip (0.5-10 μL Clear Tips, Nonpyrogenic, DNAse/RNAse Free, ExCell Bio) connected to a syringe via PTFE tubing. The syringe was prefilled with chitosan printing ink and mounted on a syringe pump (LSP02-2B, LongerPump). An illustration of the setups is presented in FIG. 3. The build plate of the 3D printer is levelled using miniature bull's-eye spirit levels. Commercially available Petri dishes (101VR20, 90 mm, Polystyrene, Non-treated, Non-sterile, ThermoFisher Scientific) are used and horizontally placed on the build plate. The zero position is set by lowering the print nozzle until it reached the Petri dish bottom surface. The customized print nozzle can experience resistance and slightly bend when sliding the Petri dish around. The Petri dish then has APAM printing matrix solution poured into it, and the printing matrix solution has a height of more than 1 cm. The Petri dish containing the printing matrix is then fixed on the build plate with adhesive tape to avoid possible movement during further printing. During the ink deposition, the print nozzle should be immersed under the printing matrix, staying in touch with the bottom surface of the Petri dish to deposit the printing ink. If interconnected channels are required, the channel is vertically punctured within 5 min and then the branch channel is printed. APAM/chitosan coacervates could self-assemble on the ink-matrix interface around the punctured position. A printing speed of 100-800 mm min⁻¹ and an ink flow rate of 3-10 mL h⁻¹ were used to print channels with different sizes. Unless otherwise specified, a wait time of 20 min after printing is employed for APAM/chitosan coacervate assembly, which is ended by refreshing the APAM matrix with deionized water. The assembly time of the vascular network-shaped channel in FIG. 2E was more than 1 h, and the ink flow rate during printing was 7 mL h⁻¹. All printing processes were done at room temperature.

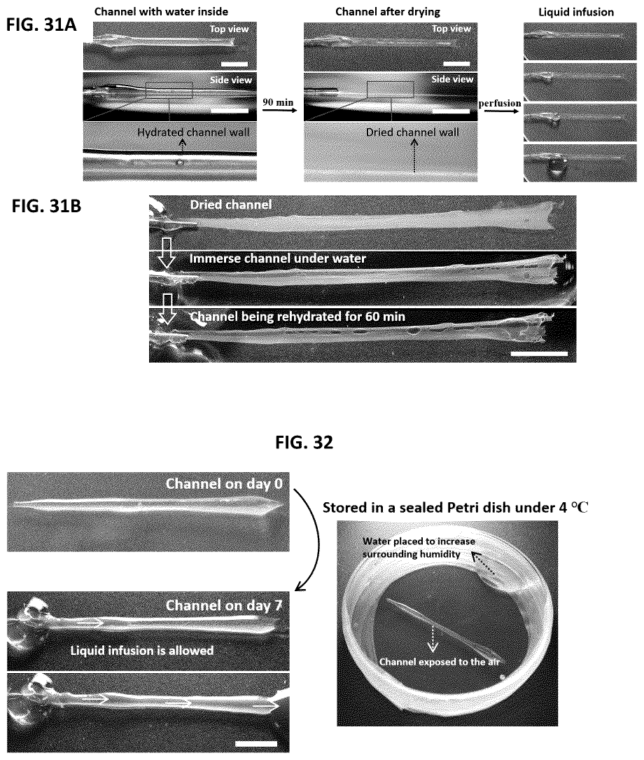

Perfusion operation of the self-assembled channel. A commercially available stainless-steel needle with an external diameter of 250 μm or 600 μm was connected to a syringe via PTFE tubing. The syringe was prefilled with deionized water (pH≈7) and mounted on a syringe pump as shown in FIG. 3. After checking there were no bubbles in the needle-tubing-syringe connection device, the needle was inserted into a channel inlet. A 20 wt % gelatin aqueous solution (40° C.) was placed around the channel inlet for sealing, which can solidify at room temperature to avoid leakage from the channel inlet. The gelatin solution was prepared by dissolving gelatin (Gelatin, CP, purchased from Aladdin, China) in deionized water under 50° C. To wash out the chitosan ink inside the channel, the channel was perfused with deionized water at a flow rate of 1-3 mL min⁻¹ for more than 10 min. After the removal of the chitosan ink, water in the syringe is replaced for solution perfusion as desired. During or before the liquid infusion into the channels, the channel walls should be kept hydrated. Liquids cannot be injected into the dry channels (FIGS. 31A & B). In FIG. 31A, liquid leakage occurs when infusing liquids into a dry channel. In FIG. 31B, the dry channel fails to be restored to its original structure even after re-hydration. Scale bars are 1 cm. However, the channels can be stored for at least 7 days if the channel walls are kept hydrated (FIG. 32). During the channel storage in FIG. 32, APAM matrix outside the channel is removed and chitosan ink inside the channel is retained. Water is placed near the channel to increase the surrounding humidity, and thus the channel wall can stay hydrated. The channel is then stored in a sealed container whose temperature is kept under 4 C°. The scale bar is 1 cm.

Optical and fluorescence microscope imaging. In all experiments, the vertical views of the printed channels were collected with a digital camera (Canon EOS 70D) or by an inverted fluorescence optical microscope (Leica microscope). The cross-sectional views of channels were collected by using a confocal laser scanning microscope (TCS SP8, Leica). For visualization under the confocal laser scanning microscope, channels were printed by ink pre-mixed with 0.02 wt % fluorescein isothiocyanate-labelled chitosan (FITC-chitosan, customized by Xi'an Ruixi Biological Technology Co. Ltd, China).

Young's modulus measurement of hydrated membranes with an AFM microscope. A 0.5 mL chitosan solution was placed on a Petri dish surface. The dish was tilted so that the solution could cover an area over 3 cm². A 5 mL APAM solution was poured on top of the chitosan solution and left standing for a given time period for self-assembly. The APAM and chitosan solutions were then refreshed with deionized water at least 10 times. After that, the membranes were immersed under deionized water, saline solutions, HCl solutions, or NaOH solutions, separately. After letting the membranes stand for at least 3 h, the membranes could physically attach to the Petri dish surface. An atomic force microscope (Nano Wizard, JPK Instruments) was used to obtain force-distance curves. The indentation test was conducted by using a scanning probe with a plateau tip (SD-PL2-CONTR-10, Silicon-SPM-Sensor with plateau tip, plateau diameter: 1.8±0.5 μm, force constant: 0.02-0.77 N m⁻¹, NANOSENSORS). During the test, both membranes and AFM tip were immersed in water or aqueous solutions. For each sample, more than 8 test points were selected, and each test point corresponded to 3-5 test results. Regions without wrinkles or bubbles under the field of the optical microscope were selected. The resulting force vs. displacement curves were analyzed by JPK Data Processing Software (Version 6.1.159, Bruker) to determine Young's modulus of the samples. A Hertz/Sneddon Model was exploited as the fitting model, and the unknown Poisson ratio was set to 0.5. The order of magnitudes of obtained results did not vary as the Poisson ratio changed from 0.5 to 0.1.

Thickness measurement of freeze-dried membranes with a SEM microscope. The reported research [22] provides a technique for preparing the self-assembled membranes for thickness measurement. The APAM solution is poured on top of the chitosan solution and a period of time is waited for self-assembly to occur. The APAM and chitosan solutions were then refreshed with deionized water at least 10 times to remove free APAM and chitosan polymers. The formed APAM/chitosan membranes were then placed above hydrophilic silicon wafers. After freezing to under −80° C. overnight, the membranes attached to silicon wafers were transferred to a vacuum freeze dryer (FD-1D-50, BIOCOOL) for 2-3 days. The freeze-dried samples were kept in an electronic dry cabinet for at least 1 day before being cracked to expose the cross-sections for thickness measurement. The assemblies are treated assemblies with a sputter coater (Bal-tec SCD 454 005) for conductive coating and their cross-sections are observed under a scanning electron microscope (LEO 1530 FEG-SEM, Zeiss, Model S4800, Hitachi). SEM images of the cross-sections of the assemblies are collected and measured with the open-source software ImageJ.

Thickness measurement of hydrated membranes with a confocal microscope. An APAM solution was mixed with 0.005 wt % rhodamine 6G (R6G, Mw=479.01 g mol⁻¹, purchased from Aladdin, China). A Chitosan solution was mixed with 0.005 wt % fluorescein sodium salt (Mw=376.27 g mol⁻¹, purchased from Aladdin, China). A 50 μL APAM solution was placed above a thin cover slide, and around 30-50 μL chitosan solution was placed beside the APAM solution. The cover slide was placed above a 100× objective immersed in a drop of oil, so membranes on the interface between the APAM and chitosan solutions were observed with the confocal microscope (Eclipse Ti2-E, Nikon). Confocal images of cross-sections of membranes were collected and measured with ImageJ.

Selective transport across channel walls. Fluorescent dye solutions were prepared by dissolving fluorescein isothiocyanate-dextran 4,000 (FITC-dex 4k, Mw=4,000 g mol⁻¹, purchased from Sigma-Aldrich, United States), fluorescein isothiocyanate-dextran 10,000 (FITC-dex 10k, Mw=10,000 g mol⁻¹, purchased from Sigma-Aldrich, United States), fluorescein isothiocyanate-dextran 40,000 (FITC-dex 40k, Mw=40,000 g mol⁻¹, purchased from Sigma-Aldrich, United States), and fluorescein isothiocyanate-dextran 70,000 (FITC-dextran 70k, Mw=70,000 g mol⁻¹, purchased from Sigma-Aldrich, United States) in deionized water, respectively. Then 2 mm wide channels were printed with 1 wt % chitosan printing ink (pH≈6) and 2 wt % APAM printing matrix (pH≈7), and the time for membrane assembly was 30 min. After removing the APAM matrix and the chitosan ink with deionized water, the channels were perfused with fluorescent dye solutions at a constant flow rate (0.5 mL h⁻¹). During the perfusion, channels were immersed in water and observed under a fluorescence optical microscope. The collected fluorescence microscope images were analyzed with the software MATLAB to obtain the normalized fluorescence intensities.

Localized trans-wall dye transport on a Y-shaped channel. The yellow dye and the red dye perfused in the channel were prepared by dissolving T/Thioflavin T (Mw=318.86 g/mol, >75%, purchased from RYON, China) and R6G in deionized water, respectively. The blue dye placed above the channel was prepared by dissolving methylene blue (MB, Mw=319.85 477 g/mol, ≥82%, purchased from Sigma-Aldrich, United States) in deionized water. Before characterizing the real-time concentration of methylene blue (MB) inside the channel, 2 mm-width channels were printed and perfused with deionized water at a flow rate of 3 mL h⁻¹. After placing a 5 μL MB droplet above the channel wall, 100 μL of solution were collected downstream from the channel outlet every 2 min. The distance between the channel outlet and the position for placing MB droplets was 1 cm. MB concentrations in the collected liquids were characterized with a Microplate Reader (SpectraMax iD3, Molecular Devices), as illustrated in FIGS. 22A-C.

Localized immobilization of enzymes on channel walls. For visualizing the immobilized enzymes on channel walls (FIGS. 24A & 24B, FIGS. 25B-25D), fluorescein isothiocyanate-labelled horseradish peroxidase (FITC-HRP, customized by Xi'an Ruixi Biological Technology Co. Ltd, China) and rhodamine B-labelled glucose oxidase (RhB-GOx, customized by Xi'an Ruixi Biological Technology Co. Ltd, China) were used. The enzymes used for glucose degradation in FIG. 28D were unlabelled HRP (Pierce Horseradish Peroxidase, 300 units mg⁻¹, purchased from Thermo Fisher Scientific, United States) and GOx (Glucose oxidase, 100 units mg⁻¹, purchased from Macklin, China). Enzymes were dissolved in deionized water and stored at −20° C. before use. To immobilize positively charged horseradish peroxidase (HRP) on the channel walls, HRP solutions were deposited close to the walls for 30 min, during which some enzymes adsorb onto the wall surface. The residual enzymes were washed away with deionized water. To immobilize negatively charged glucose oxidase (GOx) on channel walls, the wall surface was pre-coated with a chitosan layer. The chitosan layer was generated by placing chitosan solutions in contact with the channel walls for 30 minutes, followed by removal of the free chitosan by washing with deionized water. Then, GOx solutions were left in contact with the walls for 30 min for the adsorption of enzymes onto channel wall surface. To generate a GOx-HRP co-coated layer on walls in FIG. 24B, the channel wall was pre-coated with HRP enzymes. The outer surface coated with positively charged HRP can attract negatively charged GOx for GOx immobilization. The left GOx-coated region was treated with 0.5 μL, 10 mg mL⁻¹ RhB-GOx solution; the middle GOx-coated region was treated with 0.5 μL, 4 mg mL⁻¹ RhB-GOx solution; the right GOx-coated region was coated with 1 μL, 1 mg mL⁻¹ RhB-GOx solution; the left HRP-coated region was treated with 0.5 μL, 1 mg mL⁻¹ FITC-HRP aqueous solution, and the right was coated with 1 μL, 4 mg mL⁻¹ FITC-HRP aqueous solution. The GOx-coated region and HRP-coated region in FIG. 28D were treated with 2 μL GOx aqueous solution (5 mg mL⁻¹) and 2 μL HRP aqueous solution (5 mg mL⁻¹), respectively.

Characterization of glucose and starch concentrations inside channel. The solution mixture of starch and glucose was prepared by dissolving glucose (Dextrose, Mw=180.16 g mol⁻¹, anhydrous, purchased from Sigma-Aldrich, United States) and starch (Starch from corn, pharmaceutical, purchased from Aladdin, China) in deionized water. The mixed solution contained 20 wt % starch and 20 wt % glucose. 2 μL starch-glucose solution was placed above a 2 mm-width channel perfused with deionized water inside (flow rate=1 mL h⁻¹). The distance between the channel outlet and the position for placing the starch-glucose solution was 1 cm. A 100 μL of downstream liquids were collected from the channel outlet every 6 min. The glucose concentration in the collected liquids was analyzed with glucose assay kit reagents (Glucose Assay Kit with O-toluidine, purchased from Beyotime, China). The starch concentration in the collected liquids was analyzed with starch assay kit reagents (Starch Content Assay Kit, Sulfuric acid anthrone colorimetric method, purchased from Solarbio, China).

Detection of CO₂ concentrations outside the channel. Setups for detecting CO₂ concentration surrounding the channel are presented in FIGS. 30A &30B. The CO₂ sensor (CM-0024 10,000 ppm CO2 Sensor, CO2Meter) provided data of CO₂ concentration every 5 sec.

Localized trans-wall dye transport and enzyme immobilization. A VasFluidics channel was printed and exposed to the air, as presented in FIG. 26B, FIGS. 27A & 27B. The solution of green, fluorescent microspheres (Diameter=1 μm, excitation peak=488 nm, emission peak=518 nm, surface group: —COOH, 100 mg 10 mL⁻¹, purchased from Tianjin BaseLine Chromtech Research 522 Centre, China) was mixed with FITC-HRP solution (10 mg mL⁻¹) at a volume ratio of 1:1. The mixed solution was then placed above 4 downstream channels for 30 min before washing with water. Droplets of R6G and Fluorescein aqueous solutions were placed above 4 upstream channels when the channel were perfused with water inside. The channel was exposed under 405 nm light (Portable curing light source, 405 nm, 3 W, purchased from Engineering for Life (EFL), China) during data collection.

The above are only specific implementations of the invention and are not intended to limit the scope of protection of the invention. Any modifications or substitutes apparent to those skilled in the art shall fall within the scope of protection of the invention. Therefore, the protected scope of the invention shall be subject to the scope of protection of the claims.

### REFERENCES

The cited references in this application are incorporated herein by reference in their entirety and are as follows:
[1] Yuan S Y, Rigor R R. Regulation of endothelial barrier function Ch.2 (Morgan & 540 Claypool Life Sciences, California, 2011).
[2] Alberts B, Johnson A, Lewis J, Raff M, Roberts K, Walter P. Molecular Biology of the 543 Cell. 4th edition Ch. 22 (Garland Science, New York, 2002).
[3] Levick J R. An introduction to cardiovascular physiology (Butterworth-Heinemann, Oxford, 2013).
[4] Hou X, et al. Interplay between materials and microfluidics. Nat. Rev. Mater. 2, 1-15 (2017).
[5]. Whitesides G M. The origins and the future of microfluidics. Nature 442, 368-373 (2006).
[6] Hou X, Jiang L. Learning from nature: building bio-inspired smart nanochannels. ACS Nano 3, 3339-3342 (2009).
[7] Kong T, Shum H C, Weitz D A. The Fourth Decade of Microfluidics. Small 16, 2000070 (2020).
[8] Ingber D E. Human organs-on-chips for disease modelling, drug development and personalized medicine. Nat. Rev. Genet. 23, 467-491 (2022).
[9] Sontheimer-Phelps A, Hassell B A, Ingber D E. Modelling cancer in microfluidic human organs-on-chips. Nat. Rev. Cancer 19, 65-81 (2019).
[10] Rogers J, Lagally M, Nuzzo R. Synthesis, assembly and applications of semiconductor nanomembranes. Nature 477, 45-53 (2011).
[11] Forth J, Kim P Y, Xie G, Liu X, Helms B A, Russell T P. Building reconfigurable devices using complex liquid-fluid interfaces. Adv. Mater. 31, 1806370 (2019).
[12] Chao Y, Shum H C. Emerging aqueous two-phase systems: from fundamentals of interfaces to biomedical applications. Chem. Soc. Rev. 49, 114-142 (2020).
[13] Sun S, Liu T, Shi S, Russell T P. Nanoparticle surfactants and structured liquids. Colloid. Polym. Sci. 299, 523-536 (2021).
[14] Honaryar H, Amirfattahi S, Niroobakhsh Z. Associative Liquid-In-Liquid 3D Printing Techniques for Freeform Fabrication of Soft Matter. Small 19, 2206524 (2023).
[15] Shi S, Russell T P. Nanoparticle Assembly at Liquid-Liquid Interfaces: From the Nanoscale to Mesoscale. Adv. Mater. 30, 1800714 (2018).
[16] Xie G, Forth J, Chai Y, Ashby P D, Helms B A, Russell T P. Compartmentalized, all-aqueous flow-through-coordinated reaction systems. Chem 5, 2678-2690 (2019).
[17] Feng W, Chai Y, Forth J, Ashby P D, Russell T P, Helms B A. Harnessing liquid-in-liquid printing and micropatterned substrates to fabricate 3-dimensional all-liquid fluidic 589 devices. Nat. Commun. 10, 1-9 (2019).
[18] Luo G, Yu Y, Yuan Y, Chen X, Liu Z, Kong T. Freeform, Reconfigurable Embedded 22 Printing of All-Aqueous 3D Architectures. Adv. Mater. 31, 1904631 (2019).
[19] Zhang S, et al. In Situ Endothelialization of Free-Form 3D Network of Interconnected Tubular Channels via Interfacial Coacervation by Aqueous-in-Aqueous Embedded Bioprinting. Adv. Mater. 35, 2209223 (2023).
[20] Yin Y, et al. Nanoparticle/polyelectrolyte complexes for biomimetic constructs. Adv. 599 Funct. Mater. 32, 2108895 (2022).
[21] Liu T, Yin Y, Yang Y, Russell T P, Shi S. Layer-by-Layer Engineered All-Liquid 602 Microfluidic Chips for Enzyme Immobilization. Adv. Mater. 34, 2105386 (2022).
[22] Lin D, et al. Stabilizing Aqueous Three-Dimensional Printed Constructs Using 605 Chitosan-Cellulose Nanocrystal Assemblies. ACS Appl. Mater. Interfaces 12, 55426-55433 (2020).
[23] Xu R, Liu T, Sun H, Wang B, Shi S, Russell T P. Interfacial assembly and jamming of 609 polyelectrolyte surfactants: A simple route to print liquids in low-viscosity solution. 610 ACS Appl. Mater. Interfaces 12, 18116-18122 (2020).
[24] Forth J, et al. Reconfigurable printed liquids. Adv. Mater. 30, 1707603 (2018).
[25] Zhu S, et al. Aquabots. ACS Nano 16, 13761-13770 (2022).
[26] Sun H, et al. Redox-responsive, reconfigurable all-liquid constructs. J. Am. Chem. Soc. 143, 3719-3722 (2021).
[27] Gu P Y, et al. Visualizing Assembly Dynamics of All-Liquid 3D Architectures. Small 18, 2105017 (2022).
[28] Bazazi P, Stone H A, Hejazi S H. Spongy all-in-liquid materials by in-situ formation of 623 emulsions at oil-water interfaces. Nat. Commun. 13, 4162 (2022).
[29] Tang G, et al. Liquid-embedded (bio) printing of alginate-free, standalone, ultrafine, and 626 ultrathin-walled cannular structures. Proc. Natl. Acad. Sci. USA 120, e2206762120 (2023).
[30] Gonçalves R C, et al. All-Aqueous Freeform Fabrication of Perfusable Self-Standing Soft Compartments. Adv. Mater. 34, 2200352 (2022).
[31] Grosskopf A K, Truby R L, Kim H, Perazzo A, Lewis J A, Stone H A. Viscoplastic matrix 633 materials for embedded 3D printing. ACS Appl. Mater. Interfaces 10, 23353-23361 (2018).
[32] Lewis J A. Direct ink writing of 3D functional materials. Adv. Funct. Mater. 16, 2193-2204 (2006).
[33] Liu J, Zheng H, Poh P S, Machens H-G, Schilling A F. Hydrogels for engineering of perfusable vascular networks. Int. J. Mol. Sci. 16, 15997-16016 (2015).
[34] Carraher Jr C E, Seymour R. Structure-property relationships in polymers (Springer Science & Business Media, Berlin, 2012).
[35] Huei C R, Hwa H-D. Effect of molecular weight of chitosan with the same degree of deacetylation on the thermal, mechanical, and permeability properties of the prepared membrane. Carbohydr. Polym. 29, 353-358 (1996).
[36] Decher G. Fuzzy nanoassemblies: toward layered polymeric multicomposites. Science 277, 1232-1237 (1997).
[37] Mustafa M B, Tipton D L, Barkley M D, Russo P S, Blum F D. Dye diffusion in isotropic and liquid-crystalline aqueous (hydroxypropyl) cellulose. Macromolecules 26, 370-378 (1993).
[38] Müller C, et al. Precise measurement of diffusion by multi-color dual-focus fluorescence correlation spectroscopy. Europhys. Lett. 83, 46001 (2008).
[39] Yuan W, Lv Y, Zeng M, Fu B M. Non-invasive measurement of solute permeability in cerebral microvessels of the rat. Microvasc. Res. 77, 166-173 (2009).
[40] Courjean O, Gao F, Mano N. Deglycosylation of glucose oxidase for direct and efficient glucose electrooxidation on a glassy carbon electrode. Angew. Chem. 121, 6011-6013 (2009).
[41] Tan S, Gu D, Liu H, Liu Q. Detection of a single enzyme molecule based on a solid-state nanopore sensor. Nanotechnology 27, 155502 (2016).
[42] Perez S, Bertoft E. The molecular structures of starch components and their contribution to the architecture of starch granules: A comprehensive review. Starke 62, 389-420 (2010).
[43] Schultz S G, Solomon A. Determination of the effective hydrodynamic radii of small molecules by viscometry. J. Gen. Physiol. 44, 1189-1199 (1961).
[44] Eggers J, Villermaux E. Physics of liquid jets. Rep. Prog. Phys. 71, 036601 (2008).
[45] Lewis J A, Gratson G M. Direct writing in three dimensions. Mater. Today 7, 32-39 (2004).

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. Apparatus for forming channels comprising:
two polymer solutions, which are used as printing ink and matrix;
a substrate;
a 3D printer with a customized print nozzle connected to a syringe pump so that the solutions can be extruded onto the substrate, which is located on a build plate of the printer, in a desired pattern for the channels; and
wherein coacervates of the solutions self-assemble on the ink-matrix interface, locking chitosan polymers inside before they spread and forming soft elastic membranous walls.

2. The apparatus of claim 1 wherein the two polymer solutions comprise purified deionized water, anionic polyacrylamide (APAM) with an average molecular weight ≥3,000,000 g mol⁻¹, chitosan (>400 mPa s), acetic acid and sodium hydroxide (NaOH), where APAM solutions are the printing matrix and chitosan solutions are the printing ink.

3. The apparatus of claim 1 wherein the substrate is a negatively charged petri dish.

4. The apparatus of claim 1 further including a coater for applying at least one functional material coating to the walls of the channels to chemically alter their compositions so as to provide localized reactions between the channels and fluids.

5. The apparatus of claim 4 wherein the localized reaction is one of confining solutions outside a specific channel for local reagent delivery or immobilizing a local channel wall with enzymes to alter the flow of molecules through the cell walls.

6. The apparatus of claim 4 wherein the functional material has large sizes (radius or Rₕ≥3.0 nm) and carry electrostatic charges.

7. The apparatus of claim 4 wherein the coating is at least spatially distributed on a single channel with variable coating amounts.

8. The apparatus of claim 4 wherein different regions of the channel are coated simultaneously for both trans-wall transport and enzyme immobilization and the coating includes at least one of enzymes, HRP, RhB-GOx and FITC-HRP.

9. A method for forming channels comprising the steps of
preparing the printing ink by dissolving chitosan in water-diluted acetic acid and adjusting the pH by adding NaOH aqueous solution;
preparing the printing matrix by dissolving APAM in deionized water with gentle shaking overnight;
adding the printing ink to a syringe pump connected to a print nozzle of a 3D printer, while ensuring that the ink can be smoothly extruded out of the print nozzle;
pouring the printing matrix into a dish, and placing the dish onto a build plate of the 3D printer;
translating the print nozzle and extruding the ink through the nozzle, depositing the ink against the bottom of the dish in a desired pattern;
allowing the chitosan polymers and APAM polymers to self-assemble on the liquid interface between ink and matrix for more than 15 min; and
removing the matrix.

10. The method of claim 9 where the step of removing the matrix APAM printing matrix and chitosan printing ink after the self-assembly of printed channels is achieved with the use of transfer pipettes or pipette tips to remove the APAM matrix gently.

11. The method of claim 9 further including the step of applying at least one functional material coating to the walls of the channels to chemically alter their compositions so as to provide localized reactions between the channels and fluids.

12. The apparatus of claim 11 wherein the localized reaction is one of confining solutions outside a specific channel for local reagent delivery or immobilizing a local channel wall with enzymes to alter the flow of molecules through the cell walls.

13. The apparatus of claim 11 wherein the functional material has large sizes (radius or Rₕ≥3.0 nm) and carry electrostatic charges.

14. The apparatus of claim 11 wherein the coating is at least spatially distributed on a single channel with variable coating amounts.

15. The apparatus of claim 11 wherein different regions of the channel are coated simultaneously for both trans-wall transport and enzyme immobilization and the coating includes at least one of enzymes, HRP, RhB-GOx and FITC-HRP.

16. The method of claim 11 wherein the thickness of the membranous wall is adjustable from 1 μm to around 2 μm by changing the polymer concentrations, the time, and the pH during membrane assembly.

17. The method of claim 11 wherein the size of a single chamber is adjustable by applying different printing speeds and ink flow rates, wherein the size of a channel is determined by the channel length and the area of cross-section perpendicular to the length.

18. The method of claim 11 wherein the cross-sectional area perpendicular to the length is adjusted by changing the printing speed and the flow rate of printing ink.

19. The method of claim 11 further including the step of localizing the trans-wall transport of specific molecules so that liquid components within the channel can be spatiotemporally regulated by depositing solution drops directly on the channel wall after removing the printing matrix and exposing the channel to air.

20. The method of claim 19 wherein the solution drops are aqueous solutions of small molecules (Rₕ≤1.9 nm).

21. The method of claim 20 wherein the walls of the channels are modified with a coating of functional materials so as to chemically alter fluid compositions in the channels, wherein the functional materials are of large sizes (Rₕ≥3.0 nm) and carry electrostatic charges.

22. The method of claim 21 wherein a functional material is an enzyme.

23. The method of claim 21 wherein the channel is modified with two RhB-GOx-coated regions, one HRP-coated region, and an RhB-GOx and FITC-HRP co-coated region.

24. The method of claim 11 wherein the dish is a negatively charged Petri dish.

25. The method of claim 11 wherein the step of preparing the printing ink and the printing matrix, comprises the steps of:
providing deionized water, anionic polyacrylamide (APAM) with an average molecular weight ≥3,000,000 g mol⁻¹, chitosan (>400 mPa s), acetic acid and sodium hydroxide (NaOH);
dissolving the chitosan in water-diluted acetic acid,
adjusting the pH with NaOH aqueous solution;
dissolving APAM in the deionized water with gentle shaking overnight; and
using 1 wt % chitosan solution (pH≈5-6) as the printing ink and 1 wt % APAM solution (pH≈7) as the printing matrix.

26. Vascular-like channel system comprising:
channels with semipermeable walls; and
a solid substrate supporting the channels and affixed thereto so they are immobilized; and
wherein solutions are confined to the outside a specific channel for local reagent delivery, or by immobilizing a local channel wall with enzymes to alter flow-through molecules so that the trans-wall molecules vary among different regions, facilitating the simulation of glucose absorption and metabolism in vascular networks.

27. The vascular-like channel of claim 26 wherein the walls of the channels are formed by APAM and chitosan.

28. The vascular-like channel of claim 27 wherein different regions of the channel can be assigned simultaneously for both trans-wall transport and enzyme immobilization.
